(19) United States
(12) Patent Application Publication
(10) Pub. No.: US 2026/0073484 A1
(43) Pub. Date: Mar. 12, 2026

(54) GENERATING A DIGITAL VIDEO UTILIZING A SET OF ANCHOR TOKENS TO DENOISE NOISED TOKENS

(71) Applicant: Adobe Inc., San Jose, CA (US)

(72) Inventors: Tobias Hinz, Ulm (DE); Lior Shapira, Seattle, WA (US); Lakshya Lnu, San Jose, CA (US); Kevin Duarte, San Jose, CA (US); Ali Aminian, San Jose, CA (US)

(21) Appl. No.: 19/035,556

(22) Filed: Jan. 23, 2025

Related U.S. Application Data
(60) Provisional application No. 63/693,660, filed on Sep. 11, 2024.

(51) Int. Cl. G06T 5/70; G06T 5/60

(52) U.S. Cl. CPC G06T 5/70; G06T 5/60; G06T 2207/10016; G06T 2207/20084

(57) ABSTRACT

The present disclosure relates to systems, methods, and non-transitory computer-readable media that generate a digital video based on denoised tokens. In particular, the disclosed systems generate a set of image tokens from a digital image that is part of an image-to-video request. Furthermore, the disclosed systems generate a set of anchor tokens from the set of image tokens by adding a timestep embedding to the set of image tokens that indicates that the set of anchor tokens are fully denoised. Further, the disclosed systems generate combined tokens from the set of anchor tokens and noised tokens that are generated from noise. Moreover, the disclosed systems generate denoised tokens by using a diffusion transformer model to process the combined tokens. Further, from the denoised tokens, the disclosed systems generate the digital video that includes the digital image.

### CROSS REFERENCE TO RELATED APPLICATIONS

This application claims the benefit of and priority to U.S. Provisional Application No. 63/693,660, filed Sep. 11, 2024. The aforementioned application is hereby incorporated by reference in its entirety.

### BACKGROUND

Recent years have seen significant advancement in hardware and software platforms for performing generative tasks. Indeed, systems provide a variety of ways to generate static images and dynamic videos. For instance, systems create distinct architectures for generating content in different modalities. Specifically, systems tailor architecture for creating digital videos from various input prompts.

### SUMMARY

One or more embodiments described herein provide benefits and/or solve one or more problems in the art with systems, methods, and non-transitory computer-readable media that implement an artificial intelligence (hereinafter referred to as AI) architecture for executing image-to-video requests. For example, the disclosed systems generate a set of image tokens for a digital image part of an image-to-video request and further generates a set of anchor tokens from the set of image tokens by adding a timestep that indicates that the set of image tokens are fully denoised. Furthermore, in some embodiments, the disclosed systems generate denoised tokens by using a diffusion transformer model to process the set of anchor tokens and noised tokens. Moreover, in some embodiments, the disclosed systems generate a digital video based on the denoised tokens and the digital video includes at least a portion of the digital image that was part of the image-to-video request.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a generative AI digital visual system operates in accordance with one or more implementations;

FIG. 2 illustrates an example diagram of the generative AI digital visual system receiving an image-to-video request that includes a digital image and generating a digital video that includes the digital image in accordance with one or more implementations;

FIG. 3A illustrates an example diagram of the generative AI digital visual system generating text tokens from conditional prompt(s), generating a set of anchor tokens, and initializing noised tokens in accordance with one or more implementations;

FIG. 3B illustrates an example diagram of the generative AI digital visual system generating text tokens from unconditional prompt(s), generating the set of anchor tokens, and initializing noised tokens in accordance with one or more implementations;

FIG. 4 illustrates an example diagram of the generative AI digital visual system performing a first pass and a second pass through a diffusion transformer model to generate a final output token in accordance with one or more implementations;

FIG. 5 illustrates an example diagram of the generative AI digital visual system using transformer blocks of a diffusion transformer model to generate a conditional token output and an unconditional token output in accordance with one or more implementations;

FIG. 6 illustrates an example diagram of the generative AI digital visual system transforming the final token output into a digital video in accordance with one or more implementations;

FIG. 7 illustrates an example diagram of the generative AI digital visual system receiving a training video and generating image tokens in accordance with one or more implementations;

FIG. 8 illustrates an example diagram of the generative AI digital visual system adding spatial-temporal positional encodings to image tokens in accordance with one or more implementations;

FIG. 9 illustrates an example diagram of the generative AI digital visual system generating a measure of loss and modifying parameters of the diffusion transformer model in accordance with one or more implementations;

FIG. 10 illustrates a schematic diagram of the generative AI digital visual system in accordance with one or more implementations;

FIG. 11 illustrates a series of acts for generating a digital video in accordance with one or more implementations;

FIG. 12 shows an example of a diffusion model denoising noised data in a latent space in accordance with one or more implementations;

FIG. 13 shows an example of a method for media generation in accordance with one or more implementations;

FIG. 14 shows a denoising process in accordance with one or more implementations;

FIG. 15 shows a flow diagram depicting an algorithm as a step-by-step procedure for training a machine-learning model in accordance with one or more implementations;

FIG. 16 shows a flow diagram for initializing an untrained model and updating parameters of the model in accordance with one or more implementations;

FIG. 17 shows an example of a computing device in accordance with one or more implementations; and

FIG. 18 shows an example of a generative AI digital visual system apparatus (e.g., for interacting with the generative AI digital visual system 102) in accordance with one or more implementations.

### DETAILED DESCRIPTION

One or more embodiments described herein includes a frame anchoring technique for generating high-quality and accurate digital videos based on an image-to-video request. Existing systems that perform generative tasks suffer from a variety of issues related to accuracy, efficiency, and operational flexibility. Specifically, existing systems suffer from computational inaccuracies. For example, existing systems perform video generation, however, when performing generative tasks, existing systems fail to accurately include content within a generated digital video that is specified in a prompt. For instance, existing systems utilize architecture that fails to fully consider information specified in a video generation request. Thus, existing systems utilize generative architecture that generates inaccurate digital videos.

Existing systems generate video from a user-provided prompt, however existing systems suffer from generating content that does not have a strong image/video and/or text semantic alignment (e.g., existing systems generate inaccurate digital videos). Furthermore, existing systems often suffer from generating low-quality frames and/or compromised frames that fail to capture the subject of the request.

In addition, existing systems typically suffer from accurately generating a video from an input image. For example, existing systems generate videos based on an input image but fail to include the input image as a coherent frame within the video. As such, existing systems suffer from inaccurate and lower-quality videos in performing image-to-video tasks.

Related to accuracy issues, existing systems suffer from computational inefficiencies. Specifically, existing systems typically require prompting and re-prompting of the system to generate a satisfactory digital video. In some instances, even with the prompting and re-prompting of existing systems, existing systems fail to accurately generate digital videos. As such, existing systems consume excessive computational resources and time to perform generative tasks.

Moreover, conventional systems suffer from further inefficiencies by using complicated transformer-based architectures. Specifically, in order for conventional systems to generate video and image content, conventional systems typically require domain specific complexity for the model architecture to capture all the domain specific data. Accordingly, conventional systems require a lot of time and resources to run a model that generates content across domains. Furthermore, related to the accuracy and computational efficiency issues, existing systems suffer from operational inflexibilities. Specifically, existing systems suffer from implementing rigid generative models that inaccurately and inefficiently generate digital videos.

In some embodiments, a generative AI digital visual system overcomes disadvantages of existing systems. In one or more embodiments, the generative AI digital visual system implements a frame anchoring technique for generating digital videos by transforming a digital image (e.g., part of an image-to-video request) into a set of image tokens and further into a set of anchor tokens. For instance, the generative AI digital visual system transforms the set of image tokens into a set of anchor tokens by adding a timestep embedding that indicates that the set of image tokens are fully denoised.

Accordingly, the generative AI digital visual system uses a diffusion transformer model to process the set of anchor tokens (which are not noised) and noised tokens to generate denoised tokens. In particular, the set of anchor tokens act as a guide in removing noise from the noised tokens, such that the generative AI digital visual system 102 generates a digital video that contains the digital image as a frame. In other words, the generative AI digital visual system leverages the set of anchor tokens for a diffusion transformer model to fully use the information present in the digital image (e.g., the condition or anchor image) to remove noise from noised tokens.

In one or more embodiments, the generative AI digital visual system 102 uses the set of anchor tokens to support an initial frame of the generated digital video. Specifically, the generative AI digital visual system 102 uses the set of anchor tokens to ensure that the digital image ends up as the initial frame of a generated digital video. In some embodiments, the generative AI digital visual system 102 uses the set of anchor tokens to support a final frame, an intermediate frame, any subset of frames, or any portion of frames within the generated digital video. In particular, in some embodiments, the generative AI digital visual system 102 uses the set of anchor tokens to ensure that keyframes or motion frames of a generated digital video are the digital image provided as part of the image-to-video request.

In one or more embodiments, the generative AI digital visual system 102 trains a diffusion transformer model using the frame anchoring technique. Specifically, the generative AI digital visual system receives a training digital video that includes a sequence of frames. For instance, the generative AI digital visual system transforms the sequence of frames into image tokens and adds noise to image tokens of the sequence of frames except for a frame that is used to condition the diffusion transformer model (e.g., an anchor frame or condition image) to improve image to video generation during training and inference time. Accordingly, at inference time, the generative AI digital visual system demonstrates improved generative capabilities for generating digital visual content using artificial intelligence systems.

In one or more embodiments, at inference time, the generative AI digital visual system uses a trained diffusion transformer model to perform high-quality and accurate image-to-video generation. Specifically, once the diffusion transformer model is trained, the generative AI digital visual system receives an image-to-video request and performs multiple passes over a diffusion transformer model (e.g., a first pass and a second pass). For instance, the generative AI digital visual system generates a conditional token output (e.g., an output that is based on the conditional aspects of the image-to-video request) and an unconditional token output (e.g., an output that is based on unconditional aspects of the image-to-video request). Furthermore, the generative AI digital visual system combines the conditional token output and the unconditional token output to generate a final token output and further generates the digital video from the final token output.

As mentioned above, the generative AI digital visual system overcomes deficiencies of exiting systems. For example, the generative AI digital visual system improves computational accuracy relative to existing systems. As mentioned above, existing systems suffer from inaccurately including content within a generated digital video. In contrast, the generative AI digital visual system generates a set of anchor tokens (from a set of image tokens of a digital image) to use as a guide in removing noise from denoised tokens. In doing so, the generative AI digital visual system more accurately includes content specified in an image-to-video request. For instance, by keeping the set of image tokens (for the digital image, i.e., the anchor image) fully denoised, the generative AI digital visual system uses a diffusion transformer model to fully consider the information present in the digital image (e.g., the condition or anchor image) to remove noise from noised tokens.

Moreover, in contrast to existing systems which lack a strong image/video and/or text semantic alignment with an image-to-video request, in some embodiments, the generative AI digital visual system improves semantic alignment by identifying the digital image (e.g., anchor image) to generate a set of anchor tokens from and further uses the set of anchor tokens to generate the denoised tokens. In other words, the generative AI digital visual system more accurately considers an image-to-video prompt to generate a higher quality digital video and higher quality frames within the generated digital video.

Furthermore, in contrast to existing systems which typically fail to include an input image (part of a visual prompt) as a coherent frame within a generate digital video, in some embodiments, the generative AI digital visual system receives an image-to-video request that includes a digital image (e.g., the digital image is indicated as a condition of generating the digital video) and generates a set of anchor tokens from the digital image. Specifically, as mentioned, the generative AI digital visual system uses the set of anchor tokens as a guide to remove noise from noised tokens and to create a digital video that includes the digital image as a coherent frame.

Moreover, in some embodiments, the generative AI digital visual system further improves upon accuracy of existing systems by implementing unique training measures. Specifically, the generative AI digital visual system uses a training video that includes a sequence of frames and adds noise to image tokens of the sequence of frames except for image tokens of an anchor frame (e.g., a digital image). In doing so, the generative AI digital visual system optimizes parameters of a diffusion transformer model to learn to remove noise from noised tokens according to a set of anchor tokens. Thus, the generative AI digital visual system improves upon accuracy of existing systems by implementing the frame anchoring technique during training.

Furthermore, in some embodiments, the generative AI digital visual system improves upon accuracy by using spatial-temporal positional encodings. Specifically, the generative AI digital visual system adds spatial-temporal positional encodings to noised tokens to further guide a diffusion transformer model in removing noise from noised tokens.

In one or more embodiments, the generative AI digital visual system improves efficiency relative to existing systems. For example, existing systems suffer from requiring prompting and re-prompting to generate a satisfactory digital video. In contrast, the generative AI digital visual system conserves computational resources by generating a digital video that accurately conforms with an image-to-video request, thus reducing the number of prompts and re-prompts from a client device.

In addition, in one or more embodiments, the generative AI digital visual system utilizes a single stream diffusion transformer model that simplifies the complexity and streamlines the efficiency of generating digital videos from digital images. Specifically, the generative AI digital visual system feeds input data that includes the set of anchor tokens through the diffusion transformer model (without additional modulation layers or adaptive layer normalization layers, hereinafter referred to as adaLN layers) and the diffusion transformer model considers the set of anchor tokens as a guide in removing noise from noised tokens. As such, in one or more embodiments, the generative AI digital visual system reduces the time and resources needed to generate digital video from a digital image.

As also mentioned above, in one or more embodiments, the generative AI digital visual system improves upon operational flexibility relative to existing systems. For example, the generative AI digital visual system provides dynamic flexibility to generate a diverse range of digital videos. For instance, the generative AI digital visual system allows for an image-to-video request that accurately includes a digital image as one or more frames in a generated digital video. Furthermore, the generative AI digital visual system improves flexibility by allowing the image-to-video request to specify whether a visual prompt (e.g., a digital image) is to be included as an initial frame, a final frame, an intermediate frame, a portion of a frame, one or more keyframes, and/or one or more motion frames.

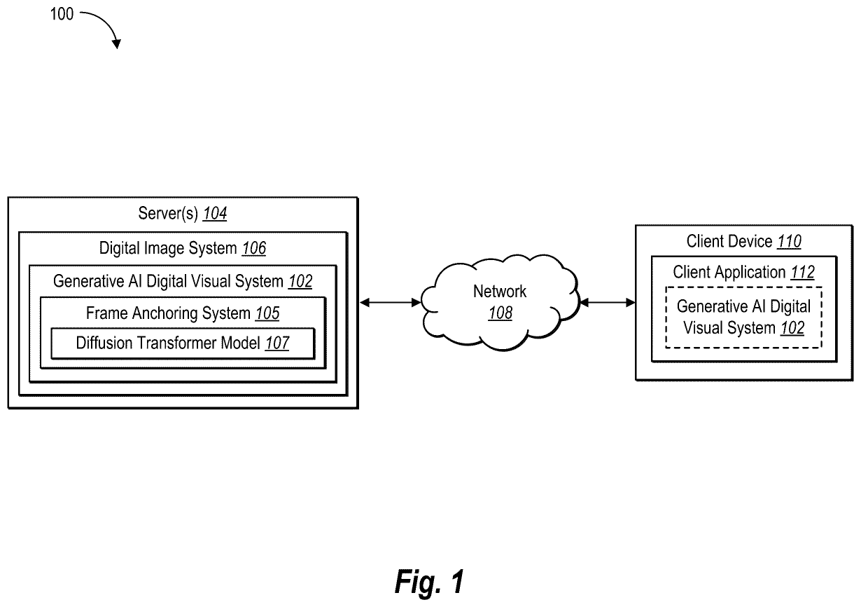

Additional details regarding the generative AI digital visual system will now be provided with reference to the figures. For example, FIG. 1 illustrates a schematic diagram of an exemplary system environment 100 in which a generative AI digital visual system 102 operates. As illustrated in FIG. 1, the system environment 100 includes server(s) 104, a digital image system 106, a network 108, and a client device 110. Additionally, FIG. 1 illustrates that the digital image system 106 includes the generative AI digital visual system 102 and the generative AI digital visual system 102 further includes a frame anchoring system 105.

Although the system environment 100 of FIG. 1 is depicted as having a particular number of components, the system environment 100 is capable of having a different number of additional or alternative components (e.g., a different number of servers, client devices, or other components in communication with the generative AI digital visual system 102 via the network 108). Similarly, although FIG. 1 illustrates a particular arrangement of the server(s) 104, the network 108, and the client device 110, various additional arrangements are possible.

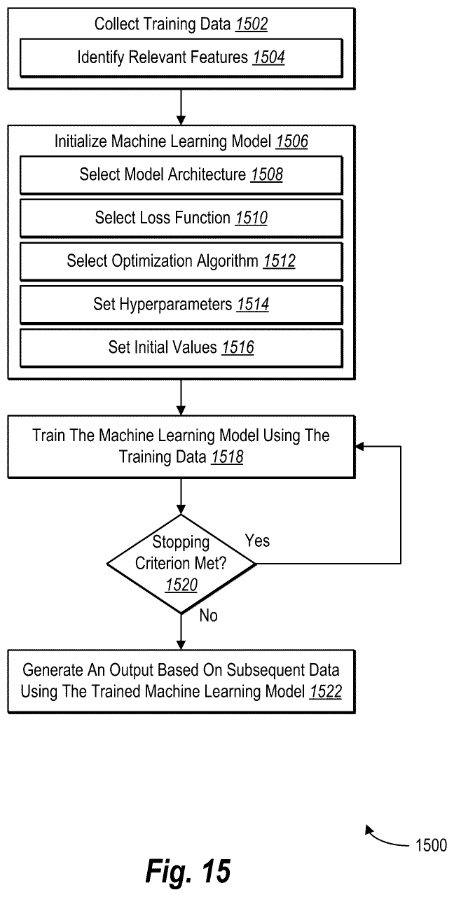

The server(s) 104, the network 108, and the client device 110 are communicatively coupled with each other either directly or indirectly (e.g., through the network 108 discussed in greater detail below in relation to FIG. 15). Moreover, the server(s) 104 and the client device 110 include one or more of a variety of computing devices (including one or more computing devices as discussed in greater detail in relation to FIG. 15).

As mentioned above, the system environment 100 includes the server(s) 104. In one or more embodiments, the server(s) 104 process input for an image-to-video request or for training one or more artificial intelligence models or generating a video from an image-to-video request. In one or more embodiments, the server(s) 104 comprise a data server. In some implementations, the server(s) 104 comprise a communication server or a web-hosting server.

In one or more embodiments, the client device 110 includes computing devices associated with the one or more user accounts that submit image-to-video requests (e.g., media generation requests) for the generative AI digital visual system 102 to generate media (e.g., based on a text prompt and/or a visual prompt). For instance, the generative AI digital visual system 102 trains one or more models (e.g., a diffusion transformer model 107 part of the frame anchoring system 105) from data by using a frame anchoring technique.

In one or more embodiments, the client device 110 includes smartphones, tablets, desktop computers, laptop computers, head-mounted-display devices, or other electronic devices. The client device 110 includes one or more software applications (e.g., the digital image application 112 includes a digital image editing application) for generating content in accordance with the digital image system 106. In one or more embodiments, the digital image application includes a software application hosted on the server(s) 104 accessible by the client device 110 through another application, such as a web browser.

To provide an example implementation, in one or more embodiments, generative AI digital visual system 102 on the server(s) 104 supports the generative AI digital visual system 102 on the client device 110. For instance, in some cases, the digital image system 106 on the server(s) 104 trains the generative AI digital visual system 102 (e.g., trains generative models associated with the frame anchoring system 105, such as the diffusion transformer model 107) to provide to the client device 110 for implementation. In one or more embodiments, the client device 110 obtains (e.g., downloads) the generative AI digital visual system 102 trained on the server(s) 104 for implementation. Once downloaded, the generative AI digital visual system 102 (e.g., which was trained on the server(s) 104) on the client device 110 provides tools for indicating instructions to the generative AI digital visual system 102 to create media (e.g., generate digital videos that include a frame provided by the client device 110).

In alternative implementations, the generative AI digital visual system 102 includes a web hosting application that allows the client device 110 to interact with content and services hosted on the server(s) 104. In other words, the client device 110 interacts with the generative AI digital visual system 102 without downloading the generative AI digital visual system 102. To illustrate, in one or more implementations, the client device 110 access a software application supported by the server(s) 104. In response, the generative AI digital visual system 102 on the server(s) 104 provides tools for inputting instructions to generate digital visual content (e.g., a video with video captions and images).

Furthermore, in some implementations, the generative AI digital visual system 102 trains one or more artificial intelligence models by using a diffusion transformer model to generate training embeddings and further utilizes the training embeddings to optimize parameters of a diffusion transformer model (e.g., a diffusion transformer model implemented by the frame anchoring system 105). Moreover, in one or more embodiments, the generative AI digital visual system 102 further generates improved positional encodings that capture spatial and temporal information for image patches in a frame of a sequence of frames and uses the improved positional encodings at inference time and training time (e.g., as data to guide the removal of noise). For instance, the generative AI digital visual system 102 leverages the positional encodings to further improve/optimize the parameters of a diffusion transformer model.

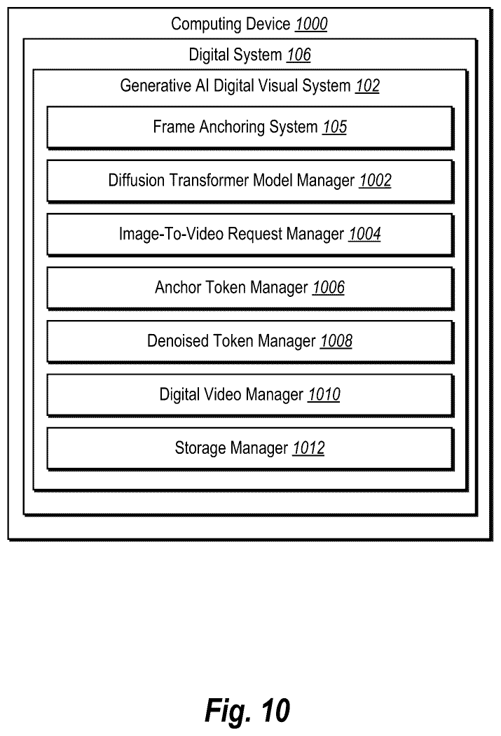

Indeed, in one or more embodiments, the generative AI digital visual system 102 is implemented in whole, or in part, by the individual elements of the system environment 100. For instance, although FIG. 1 illustrates the generative AI digital visual system 102 implemented or hosted on the server(s) 104, different components of the generative AI digital visual system 102 are able to be implemented by a variety of devices within the system environment 100. For example, one or more (or all) components of the generative AI digital visual system 102 are implemented by a different computing device or a separate server from the server(s) 104. Indeed, as shown in FIG. 1, the client device 110 includes the generative AI digital visual system 102. Example components of the generative AI digital visual system 102 will be described below with regard to FIG. 10.

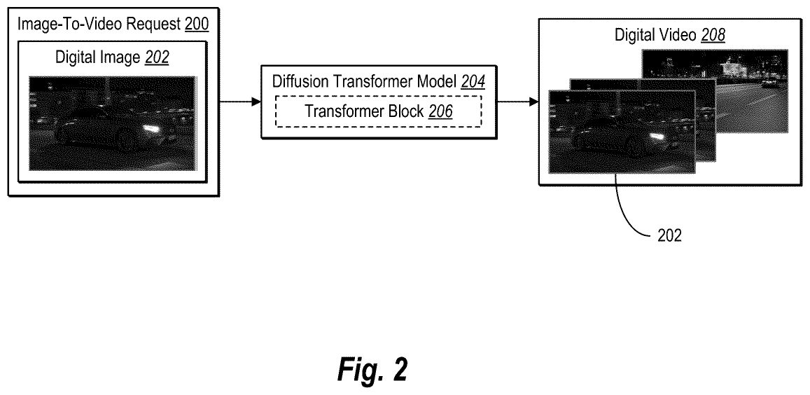

As mentioned above, in certain embodiments, the generative AI digital visual system 102 generates a digital video that includes a digital image from an image-to-video request. FIG. 2 illustrates an overview diagram of the generative AI digital visual system 102 utilizing a diffusion transformer model to generate a digital video from a digital image in accordance with one or more embodiments. For example, FIG. 2 shows an image-to-video request 200 that includes a digital image 202.

In one or more embodiments, the image-to-video request 200 refers to the generative AI digital visual system 102 receiving a request to generate a digital video. Specifically, the generative AI digital visual system 102 receives the image-to-video request 200 in the form of a prompt from a client device to generate media that conforms with the prompt. For instance, the generative AI digital visual system 102 receives the image-to-video request 200 as a visual prompt (e.g., a digital image) and/or a text prompt. To illustrate, the image-to-video request 200 includes specific parameters for the generative AI digital visual system 102, such as creating a digital video based on a provided digital image (e.g., a visual prompt with the digital image 202). Further, the image-to-video request 200 optionally includes a text prompt to generate a digital video where the text prompt specifies conditions (e.g., a conditional prompt), and unconditional prompts (e.g., flexible settings to include in the generated digital video), a format, the subject matter of the media, a style of the media, a mood or theme, and any additional details (e.g., aspect ratio, frames per second, shot size, camera angle, a type of motion such as zooming in or zooming out, etc.).

As mentioned, the image-to-video request includes a visual prompt. In one or more embodiments, a visual prompt refers to a visual input to guide the generative AI digital visual system 102 to generate media. For example, the visual prompt includes the digital image 202. Further, in some instances, the visual prompt further includes a text prompt along with the digital image 202. To illustrate, the generative AI digital visual system 102 receives the visual prompt that includes an image and a text prompt describing the media to be generated.

In one or more embodiments, the digital image 202 includes various pictorial elements. In particular, the pictorial elements include pixel values that define the spatial and visual aspects of the digital image such as text and image objects. For example, the digital image 202 is a rasterized image which includes a grid of pixels. In particular, the rasterized image includes a fixed resolution as determined by a number of pixels within the digital image 202. Furthermore, in some embodiments, the digital image 202 acts as an anchor frame or a condition frame for generating a digital video.

As shown in FIG. 2, the generative AI digital visual system 102 uses a diffusion transformer model 204 (e.g., that in some embodiments includes a transformer block 206) to process the image-to-video request 200 to generate a digital video 208. Specifically, the digital video 208 includes the digital image 202 as one of the frames. In one or more embodiments, the generative AI digital visual system 102 generates a digital video. As is discussed in more detail below, in some embodiments, the generative AI digital visual system 102 utilizes a digital video to train one or more models.

In one or more embodiments, the digital video 208 refers to a form of media that is encoded and stored in a digital format. Specifically, the digital video 208 includes a sequence of frames (e.g., images, keyframes, and/or motion frames) and each frame of the sequence of frames is displayed sequentially. For instance, the digital video 208 includes a specific resolution (480p, 720p, 1080p, 4K, 8K, etc.) which refers to a specific number of pixels being displayed (e.g., a video's resolution defines the clarity and sharpness of the digital video). Further, the digital video 208 includes a frame rate (e.g., a number of frames shown per second in a video e.g., 24 fps, 30 fps, etc.), an aspect ratio (e.g., the width and height dimensions of a frame, such as 16:9 or 4:3), compression (e.g., a file size of the digital video), and audio that goes along with the digital video (e.g., audio files that are synchronized with frames of the digital video).

In one or more embodiments, the digital video 208 includes a sequence of frames. For example, a sequence of frames refers to multiple still images that are displayed in succession to create a perception of motion. Specifically, each frame of a sequence of frames represents a single moment in time and when the sequence of frames is played together, the sequence of frames produces continuous motion and creates the content of the video. In other words, the sequence of frames includes temporal continuity where each frame in the sequence represents a next moment in time and simulates motion when moving from one frame to the next.

In one or more embodiments, the digital video 208 includes an image frame. For example, the image frame refers to a static image that represents content of the digital video 208. Specifically, in one or more embodiments, the generative AI digital visual system 102 treats a first frame (e.g., frame zero) of a sequence of frames as the image frame. In other words, the image frame refers to a first visual element displayed at the start of the video (e.g., a static image beginning of the video).

In one or more embodiments, a keyframe refers to an image frame that stores visual data for a beginning or an ending of an action or a position of an object or character. Specifically, a video includes multiple keyframes. In other words, the generative AI digital visual system 102 utilizes keyframes as complete image frames that serve as anchor points for motion. To illustrate, a video includes a sequence of frames, and the sequence of frames includes a keyframe every 16 frames.

In one or more embodiments, the digital video 208 includes at least one motion frame. For example, the generative AI digital visual system 102 utilizes motion frames as intermediate frames between keyframes to store changes or differences from a previous frame. Specifically, the generative AI digital visual system 102 utilizes the motion frames to store information related to changes between successive frames such as a change in position or color of an object from one frame to the next. Further, the generative AI digital visual system 102 utilizes the motion frames at playtime of the digital video 208 in tandem with the keyframes to create a perception of smooth motion from one keyframe to the next keyframe.

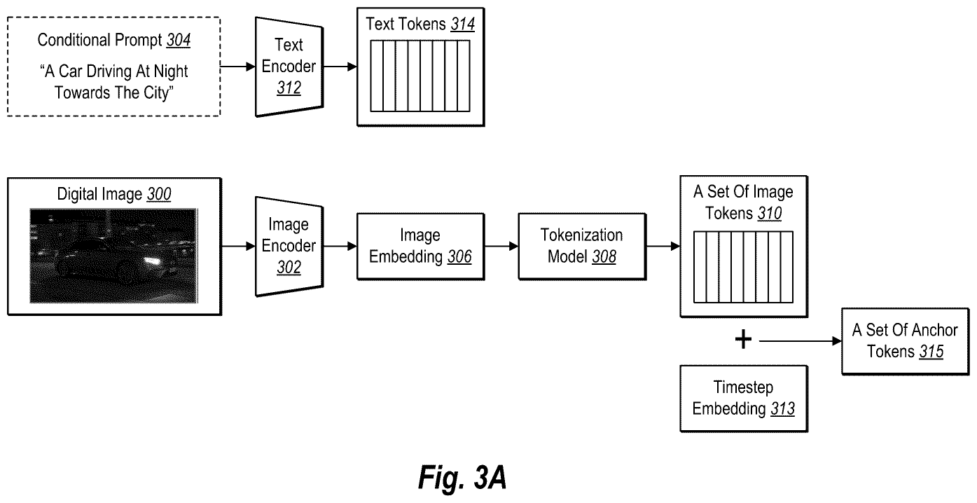

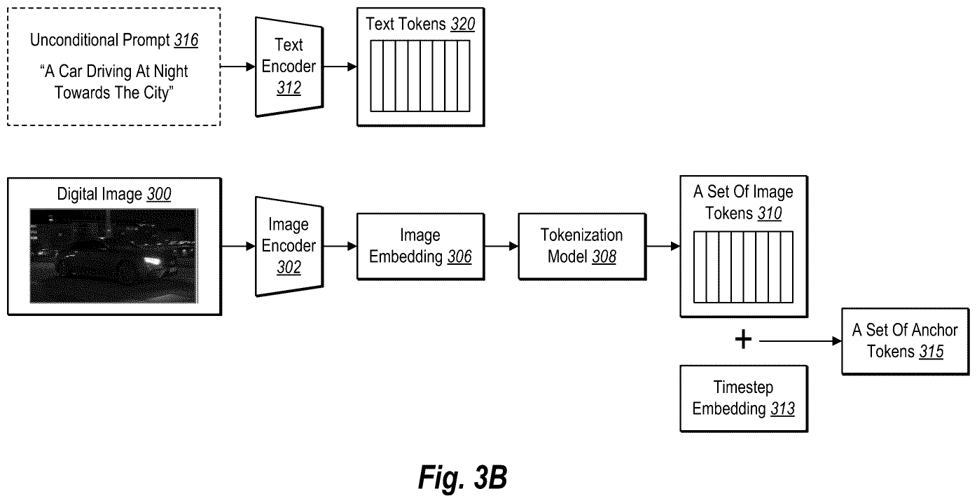

As mentioned above, the generative AI digital visual system 102 generates a set of anchor tokens. FIGS. 3A-3B illustrates the generative AI digital visual system 102 generating a set of anchor tokens and text tokens for a conditional prompt and an unconditional prompt in accordance with one or more embodiments. For example, FIGS. 3A-3B show the generative AI digital visual system 102 generating an image embedding 306 from a digital image 300 using an image encoder 302 (e.g., an encoder of a dual-VAE model mentioned below). Specifically, the digital image 300 acts as an anchor digital image/conditioning digital image that is part of an image-to-video request.

In one or more embodiments, the image encoder 302 is a neural network (or one or more layers of a neural network) that extract features relating to digital images. In some cases, the image encoder 302 refers to a neural network that both extracts and encodes features from the digital image 300. For example, the image encoder 302 includes a particular number of layers including one or more fully connected and/or partially connected layers of neurons that extract image patches from the digital image 300 and encode localized features of the digital image 300. To illustrate, in one or more embodiments, the generative AI digital visual system 102 generates the image embedding 306 that represents a complete frame of a digital image.

In one or more embodiments, the generative AI digital visual system 102 utilizes the image encoder 302 to generate an embedding (e.g., the image embedding 306). In some embodiments, the embedding includes a numerical representation (e.g., a vector) of a digital image 300. For instance, the embedding captures features and properties of the digital image 300. To illustrate, the embedding includes semantic information such as the presence of objects, shapes, and spatial relationships.

Moreover, FIGS. 3A-3B illustrates the generative AI digital visual system 102 utilizing a tokenization model 308 to generate a set of image tokens 310. In one or more embodiments, the generative AI digital visual system 102 transforms the embedding (e.g., image embedding) into image tokens (e.g., visual tokens).

For example, the generative AI digital visual system 102 utilizes the tokenization model 308 to patchify the image embedding 306. Specifically, the tokenization model 308 converts the embedding into smaller patches or grids that are treated as individual tokens for further processing (e.g., adding noise and then denoising). For instance, the generative AI digital visual system 102 utilizes patchification to handle high-dimensional image data efficiently. To illustrate, the generative AI digital visual system 102 flattens each patch of the embedding (e.g., into a single dimension vector), converts the flattened patch into a lower-dimensional representation, and maps the flattened lower-dimensional patch into a fixed-length feature vector.

Accordingly, the generative AI digital visual system 102 treats the flattened fixed-length feature vector as an image token and utilizes the diffusion transformer model to process the image token. Moreover, in some embodiments, the generative AI digital visual system 102 adds positional encodings to each patch (e.g., image token) to encode spatial information about where the patch belongs in a digital image.

In one or more embodiments, the generative AI digital visual system 102 selects a set of image patches from the digital image 300. In particular, the generative AI digital visual system 102 generates the set of image patches by sub-dividing a digital image into smaller regions. For instance, the generative AI digital visual system 102 sub-divides the digital image 300 into patches based on a predetermined resolution (e.g., 256×256), where each patch represents localized regions within the digital image 300. In some embodiments, an image patch of the set of image patches does not share any pixel values with other image patches. In some embodiments, an image patch of the set of image patches overlaps with pixel values of an adjacent image patch. Accordingly, in one or more embodiments, the generative AI digital visual system 102 sub-divides the digital image 300 into image patches where some of the image patches do not overlap with pixel values of other image patches and some of the image patches do overlap with pixel values of other image patches.

As mentioned above, the generative AI digital visual system 102 utilizes the tokenization model 308 to generate image tokens. In one or more embodiments, the set of image tokens 310 refers to image tokens from an embedding for a digital image (e.g., a digital image of a visual prompt). For instance, an image token of the set of image tokens 310 is from an image patch of the digital image 300. In other words, the generative AI digital visual system 102 utilizes the tokenization model 308 to break down the digital image 300 into image patches and further transforms each image patch into an image token. Specifically, the generative AI digital visual system 102 generates the set of image tokens 310 to use as anchor tokens in the denoising process.

As shown in FIGS. 3A-3B the generative AI digital visual system 102 adds a timestep embedding 313 to the set of image tokens 310. In one or more embodiments, the generative AI digital visual system 102 adds the timestep embedding 313 to tokens (e.g., the set of image tokens 310). For example, the timestep embedding 313 refers to an embedding that represents a specific amount of noise added to a token/set of tokens at a specific timestep. In other words, the generative AI digital visual system 102 generates the timestep embedding 313 corresponding to a first transformer block, a second timestep embedding corresponding to a second transformer block, and a third timestep embedding corresponding to a third transformer block. For instance, the timestep embedding 313 indicates a specific timestep in which noise was added to the noised tokens such that the generative AI digital visual system 102 determines how much noise to remove from a token at a specific transformer block. Moreover, in some embodiments, the generative AI digital visual system 102 adds the timestep embedding 313 to a set of tokens where the timestep embedding indicates that the set of tokens is fully denoised. In other words, in some instances, the timestep embedding indicates to the generative AI digital visual system 102 to not perform any denoising to a specific set of image tokens.

As further illustrated in FIGS. 3A-3B, the generative AI digital visual system 102 adds the timestep embedding 313 to the set of image tokens 310 to generate a set of anchor tokens 315. In one or more embodiments, the set of anchor tokens 315 refers to the timestep embedding 313 added to the set of image tokens 310. Specifically, the set of anchor tokens 315 refers to a conditioning input to the diffusion transformer model.

In other words, the set of anchor tokens 315 refers to an anchor/guide that the generative AI digital visual system uses as a guide for denoising/removing noise from noised tokens. As mentioned above, the set of image tokens 310 corresponds to the digital image 300 as part of a visual prompt. Thus, at inference time, the generative AI digital visual system 102 uses the set of anchor tokens 315 to ensure that the output (e.g., the generated digital video) includes the digital image 300 from the visual prompt. Specifically, the generative AI digital visual system 102 denoises noised tokens according to the set of anchor tokens 315. In other words, the generative AI digital visual system 102 anchors its generative mechanism to creating a digital video that includes the fully denoised content (e.g., the set of anchor tokens 315).

As shown in dotted lines in FIG. 3A, in some embodiments, the generative AI digital visual system 102 receives a conditional prompt 304 from a client device. For example, the generative AI digital visual system 102 receives the conditional prompt 304 either implicitly or expressly from an image-to-video request. Specifically, the generative AI digital visual system 102 receives the conditional prompt 304 implicitly by receiving the digital image 300, and the generative AI digital visual system 102 assumes that the digital image 300 is a condition of generating the digital video. In some embodiments, the generative AI digital visual system 102 receives the conditional prompt 304 expressly as part of a text prompt.

In one or more embodiments, the generative AI digital visual system 102 receives image-to-video request as a text prompt. In particular, the generative AI digital visual system 102 receives a text prompt from a client device that textually describes content to be included within a digital video generated by the generative AI digital visual system 102. For instance, the text prompt describes specific parameters to be included in the media generated by the generative AI digital visual system 102.

In one or more embodiments, the conditional prompt 304 refer to the generative AI digital visual system 102 generating data based on specific input conditions. Specifically, the conditional prompt 304 refer to specific instructions to guide the generation process to produce an output that aligns with the given context. For instance, in some embodiments, the digital image acts as the conditional prompt 304. In other words, the generative AI digital visual system 102 receives the digital image as a condition for generating the digital video (e.g., the digital video must include the digital image as one or more frames).

In one or more embodiments, the generative AI digital visual system 102 receives the conditional prompt 304 as part of an indication by a client device (e.g., checking a box to indicate that the uploaded digital image must be part of the generated digital video). In some embodiments, the generative AI digital visual system 102 receives the conditional prompt as instructions part of a text prompt and a visual prompt. For instance, the generative AI digital visual system 102 receives the digital image and further receives text instructions “generate a digital video of a car driving at night towards the city” or “generate a digital video of a car driving at night towards the city, like the image just provided.”

As shown in dotted lines in FIG. 3B, in some embodiments, the generative AI digital visual system 102 further receives an unconditional prompt 316. Similar to the conditional prompt 304, in some embodiments, the generative AI digital visual system 102 receives the unconditional prompt 316 as express or implicit instructions.

In one or more embodiments, the unconditional prompt 316 refer to the generative AI digital visual system 102 generating data without conditioning or guidance. Specifically, the generative AI digital visual system 102 does not rely on specific inputs or prompts to guide the output generation (e.g., the digital video). In other words, the unconditional prompt 316 does not constrain the generative process with external data (e.g., a digital image). To illustrate, the generative AI digital visual system 102 receives the unconditional prompt 316 as part of the image-to-video request (e.g., generate a video with poor resolution and bad aesthetics).

As shown in FIGS. 3A-3B, the generative AI digital visual system 102 further utilizes a text encoder 312 to process the conditional prompt 304 and the unconditional prompt 316. In one or more embodiments, the generative AI digital visual system 102 utilizes the text encoder 312 to process a text prompt. In particular, the text encoder includes a component of a neural network to transform textual data (e.g., the text prompt) into a numerical representation.

For instance, the generative AI digital visual system 102 utilizes the text encoder 312 to transform the text prompt into a text encoding (e.g., text tokens). Further, the generative AI digital visual system 102 utilizes the text encoder in a variety of ways. For instance, the generative AI digital visual system 102 utilizes the text encoder to i) determine the frequency of individual words in the text prompt (e.g., each word becomes a feature vector), ii) determines a weight for each word within the text prompt to generate a text vector that captures the importance of words within a text prompt, iii) generates low-dimensional text vectors in a continuous vector space that represents words within the text prompt, and/or iv) generates contextualized text vectors by determining semantic relationships between words within the text prompt.

In one or more embodiments, the generative AI digital visual system 102 generates text tokens 314 from the conditional prompt 304 and text tokens 320 from the unconditional prompt 316. For example, the generative AI digital visual system 102 utilizes the text encoder 312 to generate a representation of the text prompt for a machine learning task. Specifically, a single text token refers to a word, a sub-word, or a character (e.g., “the,” “on,” “cat,” “t,” “showcasing,” “show,” “casing,” etc.). Furthermore, the generative AI digital visual system 102 generates tokens representing special meaning or purposes such as the beginning or an end of a sentence.

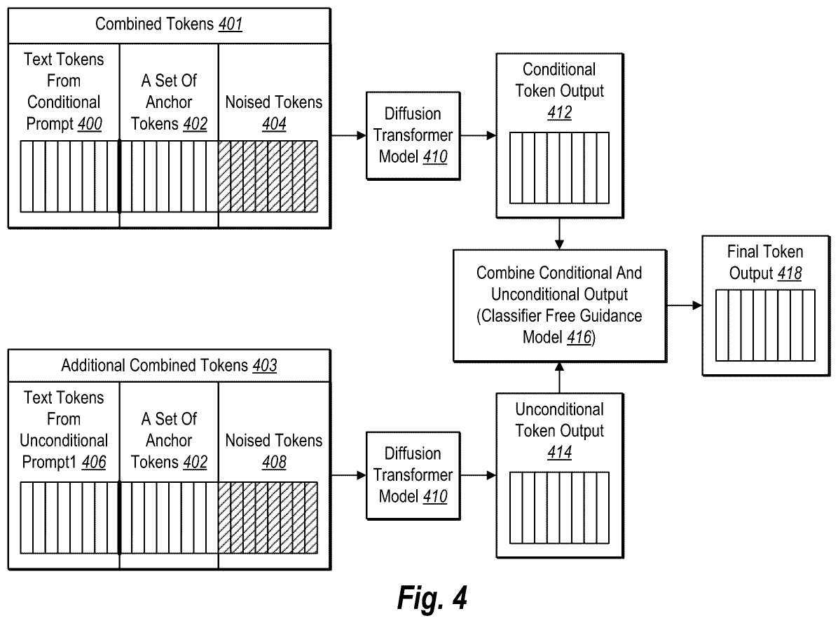

As mentioned above, the generative AI digital visual system 102 utilizes multiple passes through a diffusion transformer model to generate a final output token. FIG. 4 illustrates the generative AI digital visual system 102 performing a first pass and a second pass to generate a final output token in accordance with one or more embodiments. For example, FIG. 4 shows the generative AI digital visual system 102 utilizing a diffusion transformer model 410 to generate a final token output 418.

In one or more embodiments a machine learning model includes a computer algorithm or a collection of computer algorithms that is trained and/or tuned based on inputs to approximate unknown functions. For example, a machine learning model includes a computer algorithm with branches, weights, or parameters that changed based on training data to improve for a particular task. Thus, a machine learning model utilizes one or more learning techniques to improve in accuracy and/or effectiveness. Example machine learning models include various types of decision trees, support vector machines, Bayesian networks, random forest models, or neural networks (e.g., deep neural networks).

Similarly, a neural network includes a machine learning model of interconnected artificial neurons (e.g., organized in layers) that communicate and learn to approximate complex functions and generate outputs based on a plurality of inputs provided to the model. In some instances, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a transformer neural network, a generative adversarial neural network, a graph neural network, a diffusion neural network, or a multi-layer perceptron. In some embodiments, a neural network includes a combination of neural networks or neural network components.

In one or more embodiments, the generative AI digital visual system 102 utilizes a diffusion model as the neural network. For example, the diffusion model refers to a generative machine learning model that reconstructs data by removing noised input data. Specifically, the generative AI digital visual system 102 trains the diffusion model to remove noise, compares a denoised representation to a ground truth, and modifies parameters of the diffusion model.

In one or more embodiments, the generative AI digital visual system 102 utilizes a diffusion transformer model. Specifically, the diffusion transformer model refers to a model architecture that leverages principles of diffusion models with a transformer architecture. For example, the diffusion transformer model includes deep learning self-attention mechanisms that process sequential data. For instance, the diffusion transformer model establishes relationships between elements in a sequence using self-attention mechanisms. To illustrate, the generative AI digital visual system 102 utilizes the diffusion transformer model to denoise noised representations (e.g., noised tokens) to reconstruct data and generate media (e.g., video, images, text, etc.).

In one or more embodiments, a first pass refers to the generative AI digital visual system 102 passing an initial input through the diffusion transformer model 410. Specifically, the generative AI digital visual system 102 generates a conditional token output 412 from the first pass.

FIG. 4 illustrates the generative AI digital visual system 102 generating a combined token 401. For example, FIG. 4 shows the combined token 401 including text tokens 400 from conditional prompt, a set of anchor tokens 402, and noised tokens 404. Specifically, at inference time, the generative AI digital visual system 102 initializes the noised tokens 404.

In one or more embodiments, the generative AI digital visual system 102 initializes the noised tokens 404 from a noise distribution to generate the noised tokens 404. Specifically, at inference time (e.g., runtime), the generative AI digital visual system 102 utilizes the diffusion transformer model 410 to process the noised tokens 404. For instance, the generative AI digital visual system 102 initializes the noised tokens 404 and processes the noised tokens 404 along with the set of anchor tokens 402. For instance, the generative AI digital visual system 102 generates the noised tokens 404 by adding Gaussian noise sampled from a normal distribution with a mean of zero and a specified standard deviation, where the noise distribution ranges from t=0 to t=1000, t=1000 indicates that the token is fully noised, and t=0 indicates that the token is fully denoised.

In one or more embodiments, the combined token 401 refers to the generative AI digital visual system 102 combining (e.g., concatenating) the set of anchor tokens 402 and the noised tokens 404 to pass through a diffusion transformer model. Specifically, the combined token 401 refers to the generative AI digital visual system 102 generating a combined input for a first pass through the diffusion transformer model 410. In some embodiments, the generative AI digital visual system 102 also combines the text tokens 400 with the set of anchor tokens 402, and the noised tokens 404 to generate the combined token 401. Specifically, the generative AI digital visual system 102 generates the combined token 401 from text tokens for the conditional prompt of an image-to-video request.

As illustrated in FIG. 4, the generative AI digital visual system 102 generates the conditional token output 412 from a first pass through the diffusion transformer model 410. In one or more embodiments, the conditional token output 412 refers to the denoised tokens generated by the generative AI digital visual system 102 processing the combined token 401. Specifically, the generative AI digital visual system 102 uses the combined token 401 to generate denoised tokens according to the set of anchor tokens 402 (e.g., the denoising process is guided by the digital image). Thus, the conditional token output 412 refers to data that indicates the conditional aspects of an image-to-video request.

Furthermore, as shown, the generative AI digital visual system 102 further performs a second pass to generate an unconditional token output 414. In one or more embodiments, a second pass refers to the generative AI digital visual system 102 passing a second input through the diffusion transformer model 410. Specifically, the generative AI digital visual system 102 generates the unconditional token output 414 from the second pass. For example, the generative AI digital visual system 102 generates the unconditional token output 414 from an additional combined token 403.

In one or more embodiments, the additional combined token 403 refers to the generative AI digital visual system 102 combining (e.g., concatenating) the set of anchor tokens 402 and noised tokens 408 for a second pass through the diffusion transformer model 410. In some embodiments, the generative AI digital visual system 102 generates the additional combined token 403 by combining text tokens 406 from the unconditional prompt of the image-to-video request, the set of anchor tokens 402, and the noised tokens 408 (e.g., noised tokens initialized for the combined token 401 or additional noised tokens that are either contain a same level of noise as the noised tokens 404 or a different level of noise as the noised tokens 404).

Although the additional combined token 403 is for a second pass and uses the text tokens 406 from the unconditional prompt, in one or more embodiments, the generative AI digital visual system 102 uses the set of anchor tokens 402 on the second pass. In using the set of anchor tokens 402 for both the first pass and the second pass, the generative AI digital visual system 102 improves the accuracy and quality of a generated digital video (e.g., especially if the objective is to include a digital image within the generated digital video).

As shown in FIG. 4, the generative AI digital visual system 102 further utilizes the diffusion transformer model 410 to generate the unconditional token output 414 from the additional combined token 403. Specifically, the generative AI digital visual system 102 generates the unconditional token output 414 based on the unconditional prompt and is further guided in the denoising process by the set of anchor tokens 402. Thus, the unconditional token output 414 indicates unconditional aspects of the image-to-video request.

FIG. 4 further shows the generative AI digital visual system 102 generating a final token output 418 from the conditional token output 412 and the unconditional token output 414. In one or more embodiments, the final token output 418 refers to a combination of the conditional token output 412 and the unconditional token output 414. Specifically, the final token output 418 refers to the generative AI digital visual system 102 using a classifier free guidance model 416 to encourage the diffusion transformer model 410 to generate a digital video based on either the conditional token output 412 or the unconditional token output 414. For instance, the generative AI digital visual system 102 uses the final token output 418 to generate the digital video.

In one or more embodiments, the classifier free guidance model 416 refers to a model that does not rely on an express classifier. Specifically, the generative AI digital visual system 102 uses the classifier free guidance model 416 to steer an output of the diffusion transformer model 410 towards desired characteristics. For instance, the generative AI digital visual system 102 uses a weight to indicate whether to favor the conditional or unconditional output more heavily. In some embodiments, the generative AI digital visual system 102 uses the classifier free guidance model 416 to interpolate between the conditional token output 412 and the unconditional token output 414. Specifically, the interpolation includes a guidance scale that encourages the diffusion transformer model to generate the digital video based on the conditional token output.

As discussed above, the generative AI digital visual system 102 utilizes the set of anchor tokens 402 to guide the removal of noise and to anchor a digital image as a certain frame within a generated digital video. In some embodiments, the set of anchor tokens 402 corresponds to an initial frame of a digital video. For instance, the image-to-video request includes a digital image and further indicates that the generated product should include the digital image as the initial frame of the digital video.

In some embodiments, the set of anchor tokens 402 corresponds to an intermediate frame of a digital video. For instance, the image-to-video request includes a digital image and further indicates that the generated product should include the digital image as one or more of the intermediate frames of the video. In some embodiments, the set of anchor tokens 402 corresponds to a final frame of a digital video. For instance, the image-to-video request includes a digital image and further indicates that the generated product should include the digital image as the last or final frame of the video.

In some embodiments, the set of anchor tokens 402 corresponds to a keyframe of a digital video. For instance, the image-to-video request includes a digital image and further indicates that the generated product should include the digital image as one or more keyframes. In some embodiments, the set of anchor tokens 402 corresponds to a motion frame of a digital video. For instance, the image-to-video request includes a digital image and further indicates that the generated product should include the digital image as one or more motion frames.

In some embodiments, the set of anchor tokens 402 corresponds to a portion of a frame of a digital video. For instance, the image-to-video request includes a digital image and further indicates that the generated product should include the digital image as a portion of a frame (e.g., first, intermediate, last, keyframe, or motion frame). In other words, the generative AI digital visual system 102 uses the digital image to encompass a partial frame in the generated digital video and fills in the rest of the frame with additional content.

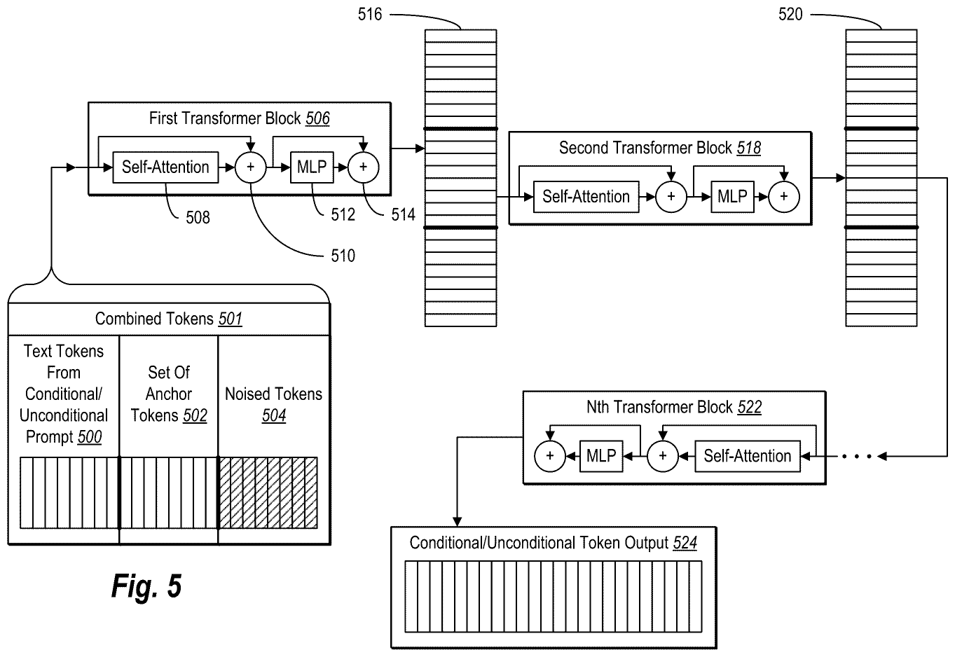

As mentioned above, the generative AI digital visual system 102 utilizes a diffusion transformer model with a streamlined architecture. FIG. 5 illustrates the generative AI digital visual system 102 utilizing transformer blocks of a diffusion transformer model to generate a conditional token output and an unconditional token output in accordance with one or more embodiments. For example, FIG. 5 shows the generative AI digital visual system 102 processing a combined token 501 that includes text tokens 500 (e.g., from the conditional prompt for generating a conditional token output or from the unconditional prompt for generating an unconditional token output), a set of anchor tokens 502, and noised tokens 504.

As shown in FIG. 5, the generative AI digital visual system 102 utilizes a first transformer block 506 of a diffusion transformer model to process the combined token 501. In one or more embodiments, a transformer block refers to an individual block in a single stream transformer. Specifically, the generative AI digital visual system 102 utilizes a transformer block of a single stream transformer to remove noise from a noised token. For instance, for a single stream transformer with multiple transformer blocks, the generative AI digital visual system 102 utilizes a first transformer block to remove some noise from a noised token to generate an intermediate denoised token.

In one or more embodiments, the generative AI digital visual system 102 utilizes transformer blocks to remove at least some noise from the noised tokens 504. For instance, the generative AI digital visual system 102 generates an intermediate denoised token by using the first transformer block 506. Specifically, an intermediate denoised token refers to a partially noised token. Specifically, once the generative AI digital visual system 102 utilizes the single stream transformer to remove all the noise from the noised tokens, the generative AI digital visual system 102 generates the denoised tokens (e.g., conditional/unconditional token output 524).

FIG. 5 shows that the first transformer block 506 includes a self-attention layer 508, a combined self-attention layer output 510, a multi-layer perceptron 512, and a multi-layer perceptron output 514. In one or more embodiments, the self-attention layer 508 refers to layer that captures the importance of different tokens (e.g., words or patches) in a sequence relative to each other. Specifically, the generative AI digital visual system 102 utilizes the self-attention layer 508 to capture relationships and dependencies between tokens (e.g., for both short-range and long-range dependencies).

In other words, the generative AI digital visual system 102 utilizes the self-attention layer 508 to determine how much attention a token should give to another token. To illustrate, the generative AI digital visual system 102 utilizes the self-attention layer 508 to generate three vectors for each token, 1) a query vector (e.g., represents the token seeking information from other tokens), 2) a key vector (e.g., represents the token providing information to other tokens), and 3) a value vector (e.g., represents the actual content of the token).

In one or more embodiments, the generative AI digital visual system 102 utilizes the self-attention layer 508 to generate a self-attention layer output that represents an updated set of intermediate noised tokens (e.g., or denoised tokens) that incorporate information from other noised tokens (e.g., the updated set of noised tokens represents relationships between tokens). In one or more embodiments, the generative AI digital visual system 102 further combines the self-attention layer output with the initial input to the transformer block corresponding to the self-attention layer to generate the combined self-attention layer output 510.

In one or more embodiments, a generative AI digital visual system 102 utilizes the multi-layer perceptron 512. For example, the multi-layer perceptron 512 refers to an artificial neural network with multiple layers of neurons that are fully connected. Specifically, the multi-layer perceptron 512 includes an input layer, where the input data is fed into the network, hidden layers (e.g., intermediate layers between an input and output layer, where the hidden layers receive input from all the neurons in the previous layer), and an output layer that generates the multi-layer perceptron output 514 (e.g., by combining the combined self-attention layer output with the output from the multi-layer perceptron 512).

FIG. 5 shows the generative AI digital visual system 102 generating a first set of intermediate denoised tokens 516 and utilizing a second transformer block 518 to further generate a second set of intermediate denoised tokens 520. Moreover, FIG. 5 shows the generative AI digital visual system 102 utilizing a Nth transformer block 522 to generate the conditional/unconditional token output 524.

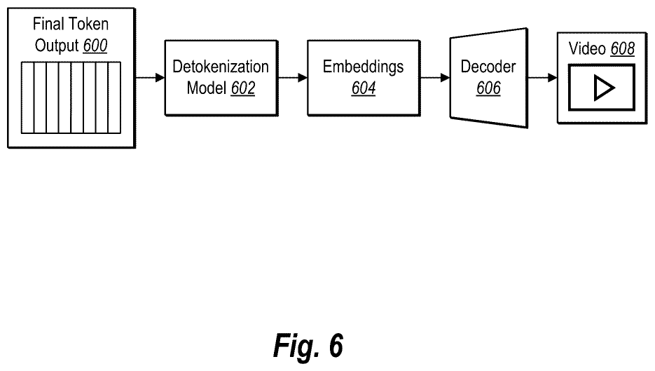

FIG. 6 illustrates the generative AI digital visual system 102 transforming a final token output into a digital video in accordance with one or more embodiments. For example, FIG. 6 shows the generative AI digital visual system 102 utilizing a detokenization model 602 to process a final token output 600.

In one or more embodiments, the generative AI digital visual system 102 transforms the final token output 600 (e.g., denoised tokens) into embeddings by utilizing the detokenization model 602. For example, the generative AI digital visual system 102 utilizes the detokenization model 602 to unpatchify denoised tokens. Specifically, unpatchification involves a reverse process of patchification to reconstruct an image (e.g., a sequence of frames) from a set of denoised tokens (e.g., the final token output 600).

For instance, the generative AI digital visual system 102 rearranges the denoised tokens (e.g., the final token output 600) and combines the rearranged denoised tokens into an initial (original) image structure/frame. In other words, the generative AI digital visual system 102 utilizes the detokenization model 602 to rearrange tokens to resemble embeddings 604 (e.g., an entire frame put together).

Furthermore, in some embodiments, the generative AI digital visual system 102 utilizes a decoder 606 to process the denoised tokens (which have been unpatchified) and generates a media item such as a digital video 608. In one or more embodiments, the generative AI digital visual system 102 utilizes the decoder 606 that includes one or more layers (e.g., linear transformation, self-attention layer, softmax layer, etc.) to transform the embeddings 604 into the digital video 608. Specifically, the decoder 606 transforms denoised tokens in the latent space to images/frames in the pixel space. In one or more embodiments, the generative AI digital visual system 102 utilizes one or more decoders of a dual-variational autoencoder model, which is described in application Ser. No. 18/930,665, titled DUAL-VAE FOR MORE EFFICIENT AND EFFECTIVE DIFFUSION MODEL TRAINING, filed on Oct. 29, 2024, which is fully incorporated by reference herein.

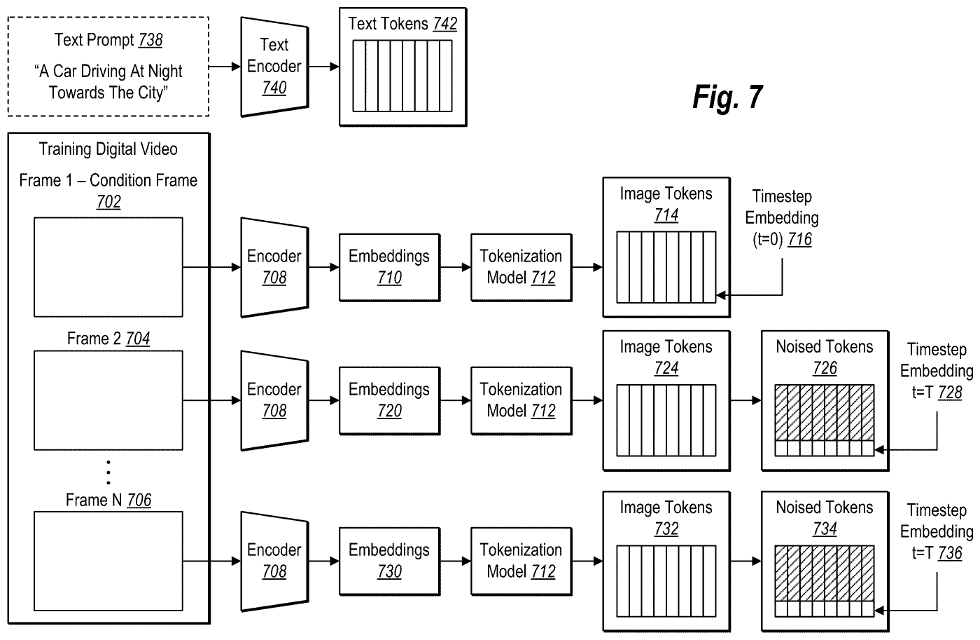

As mentioned above, the generative AI digital visual system 102 trains a diffusion transformer model in a manner to more accurately include a digital image in a generated digital video. FIG. 7 illustrates the generative AI digital visual system 102 receiving a training digital video and generating image tokens (e.g., a set of training tokens) from the training digital video in accordance with one or more embodiments. For example, FIG. 7 shows that at training time, the generative AI digital visual system 102 receives a training digital video that includes a sequence of frames (e.g., a sequence of training frames). To illustrate, a sequence of training frames of a training digital videos includes a hundred image tokens, where the first ten tokens correspond to a first frame, and the next ninety image tokens correspond to the next nine frames of the sequence of frames (e.g., ten tokens per frame).

FIG. 7 illustrates the generative AI digital visual system 102 utilizing an encoder 708 to generate embedding 710 for a first frame 702, embedding 720 for a second frame 704, and embedding 730 for an Nth frame 706. Furthermore, FIG. 7 shows the generative AI digital visual system 102 utilizing a tokenization model 712 to generate image tokens 714 for the first frame 702, image tokens 724 for the second frame 704, and image tokens 732 for the Nth frame 706.

In one or more embodiments, at training time, the generative AI digital visual system 102 adds noise to the image tokens (e.g. clean tokens corresponding to frames of a training video) over several timesteps. For instance, the generative AI digital visual system 102 adds noise to tokens over a number of timesteps corresponding to a number of transformer blocks (e.g., denoising blocks) in the diffusion transformer model. Specifically, the generative AI digital visual system 102 randomly samples from the noise distribution to determine how much noise (t ranges from 0-1000) to add to the clean image tokens.

In some embodiments, the generative AI digital visual system 102 adds the same amount of noise to all the image tokens during training, while in some embodiments, the generative AI digital visual system 102 varies the amount of noise added to tokens. Specifically, FIG. 7 shows the generative AI digital visual system 102 adding noise to image tokens 724 to generate noised tokens 726 and adding noise to image tokens 732 to generate noised tokens 734 (e.g., noised training tokens). However, as illustrated in FIG. 7, the generative AI digital visual system 102 does not add any noise to the image tokens 714 (e.g., indicated by t=0) as the image tokens 714 is from the first frame 702 which is being used as a condition/anchor frame (e.g., the training anchor tokens).

As further shown, the generative AI digital visual system 102 adds timestep embedding 716 to the image tokens 714, adds timestep embedding 728 to the image tokens 724, and adds timestep embedding 736 to the image tokens 732. As discussed above, the timestep embeddings indicate to the generative AI digital visual system 102 utilizing a diffusion transformer as to the amount of noise added to the image tokens. Thus, as shown in FIG. 7, t=T indicates that the noised tokens 726 and the noised tokens 734 are fully noised.

As discussed above in context of inference time, the generative AI digital visual system 102 utilizes a set of anchor tokens (e.g., the image tokens 714 with no noise added that act as the training anchor tokens) to remove noise from noised tokens. In one or more embodiments, at training time, the generative AI digital visual system 102 also uses the set of anchor tokens (e.g., the image tokens 714 with no noise added as indicated by the timestep embedding 716) to remove noise from the noised tokens 726 and the noised tokens 734. Specifically, the noised tokens originate from a sequence of frames (e.g., excluding the anchor frame, which is the frame used to create the set of anchor tokens at training time). Accordingly, the generative AI digital visual system 102 uses the set of anchor tokens (e.g., the image tokens 714) at training time to guide the denoising process.

Moreover, FIG. 7 shows that in one or more embodiments, the generative AI digital visual system 102 further utilizes a text prompt 738 at training time. Specifically, FIG. 7 shows the text prompt 738 as “a car driving at night towards the city.” Furthermore, FIG. 7 shows the generative AI digital visual system 102 utilizing a text encoder 740 to generate text tokens 742.

In one or more embodiments, the generative AI digital visual system 102 further staggers the anchor frames across multiple frames of a sequence of frames. Specifically, for a sequence of frames that includes 50 frames, the generative AI digital visual system 102 utilizes the first, the eleventh, the twenty-first, the thirty-first and the forty-first frames as the anchor frames for training purposes. For instance, the generative AI digital visual system 102 optimizes a diffusion transformer model to treat a subset of frames as the anchor frames for removing noise from noised tokens.

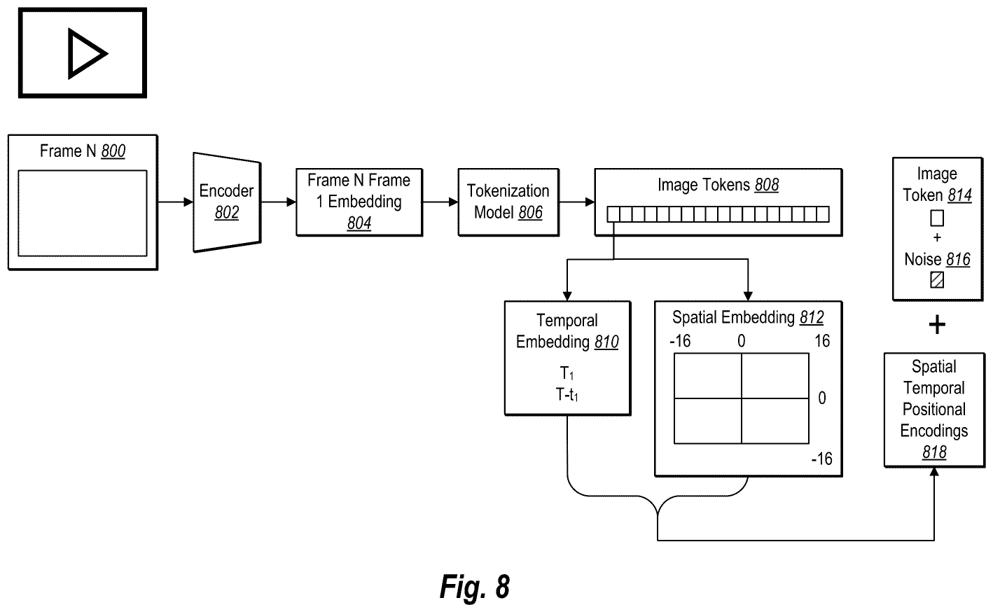

FIG. 8 further illustrates the generative AI digital visual system 102 adding spatial-temporal positional encodings to noised tokens and/or the set of anchor tokens in accordance with one or more embodiments. For example, FIG. 8 shows the generative AI digital visual system 102 generating a frame N embedding 804 for frame N 800 by using an encoder 802. Furthermore, FIG. 8 shows the generative AI digital visual system 102 utilizing a tokenization model 806 to generate image tokens 808 from the frame N embedding 804. Moreover, in some embodiments, the generative AI digital visual system 102 generates a temporal embedding 810 and a spatial embedding 812 for an image token 814 of the image tokens 808.

In one or more embodiments, the spatial embedding 812 refers to a representation of spatial relationships and positions of visual elements within a frame (e.g., an image) of a sequence of frames. Specifically, the spatial embedding 812 includes an indication of where objects/elements in a frame are located, the orientation of objects/elements, the size of objects/elements, and their spatial relationship with different regions of the frame that they are located within. For instance, the generative AI digital visual system 102 utilizes coordinate information (e.g., x-dimension and y-dimension, and in some embodiments a z-dimension) for objects/elements within a frame.

In some embodiments, the spatial embedding 812 indicates absolute position within a frame and in some embodiments, the spatial embedding 812 indicates relative position (e.g., relative to other objects/elements within a frame). In one or more embodiments, the generative AI digital visual system 102 utilizes a centered two-dimensional coordinate map to generate the spatial embedding 812 of the image token 814 with noise 816 added to the image token 814.

In one or more embodiments, the temporal embedding 810 refers to a representation of a frame within a sequence of visual frames. Specifically, the generative AI digital visual system 102 utilizes the temporal embedding 810 to capture motion information, action sequences, and transitions between frames within a sequence of frames. In other words, the generative AI digital visual system 102 generates the temporal embedding 810 to create a representation of sequential dependencies between frames of a sequence of frames.

In one or more embodiments, the generative AI digital visual system 102 generates the temporal embedding 810 based on a timestamp and an inverse timestamp. For example, the generative AI digital visual system 102 determines a timestamp for the image token 814 (e.g., for a first frame of a sequence of frames of the video). Specifically, a timestamp of a first frame refers to a specific point in time at which a frame of the image token 814 appears within the overall video or the sequence of frames, relative to the start of the video.

Furthermore, the generative AI digital visual system 102 determines an inverse timestamp, which refers to a difference in a total length of the video and the temporal position (e.g., current position) of the frame of the image token 814 relative to the sequence of frames. Moreover, the generative AI digital visual system 102 combines the timestamp and the inverse timestamp of the image token 814 with the noise 816 to generate the temporal embedding 810.

To illustrate, the generative AI digital visual system 102 utilizes the methods discussed in application Ser. No. 18/930,681, titled POSITIONAL EMBEDDING AND TRAINING TECHNIQUES FOR A DIFFUSION MODEL, filed on Oct. 29, 2024, which is fully incorporated by reference herein to generate the temporal embedding 810 and the spatial embedding 812.

As further shown in FIG. 8, the generative AI digital visual system 102 combines the spatial embedding 812 and the temporal embedding 810 to generate spatial-temporal positional encodings 818. In one or more embodiments, the spatial-temporal positional encodings 818 refer to a data representation of information relating to both spatial relationships and positions of visual elements within a frame and motion information, action sequences, and transitions between frames within a sequence of frames (e.g., sequential dependencies between frames). Specifically, the spatial-temporal positional encodings 818 includes a combined data representation that captures information from the visual dimension and the temporal dimension. Accordingly, the generative AI digital visual system 102 utilizes the spatial-temporal positional encodings 818 to remove noise from noised tokens (e.g., the noised set of the image tokens 808) in a high-quality and accurate manner (e.g., to incorporate the context indicated by the data in the spatial-temporal positional encodings 818).

Further, as shown in FIG. 8, the generative AI digital visual system 102 combines/adds the image token 814 with the noise 816 with the spatial-temporal positional encodings 818 (e.g., to generate a combined noised token with spatial-temporal positional encodings). Thus, the generative AI digital visual system 102 processes the image token 814 with the noise 816 and the spatial-temporal positional encodings 818 using a diffusion transformer model to remove noise according to the spatial-temporal positional encodings 818. To reiterate, the generative AI digital visual system 102 utilizes the spatial-temporal positional encodings 818 in tandem with the set of anchor tokens (discussed above) as a guide to remove noise from noised tokens.

In one or more embodiments, the generative AI digital visual system 102 utilizes the spatial-temporal positional encodings 818 (e.g., the combined noised token with spatial-temporal positional encodings) as a foundation for anchoring image token(s) or an entire frame in a generated digital video. Specifically, the spatial-temporal positional encodings 818 is a combined data representation that captures information from the visual dimension and the temporal dimension (e.g., the encoding contains information such as where a visual component should spatially and temporally appear).

As such, the generative AI digital visual system 102 uses the spatial-temporal positional encodings 818 as an anchor to indicate to the diffusion transformer model to include an image token, multiple image tokens, or an entire image frame at specific instances in a generated digital video. For instance, the generative AI digital visual system 102 leverages the spatial-temporal positional encodings 818 to indicate that an image patch (e.g., an image patch corresponding to an image token) should be included in every other frame of a digital video. In other words, the generative AI digital visual system 102 uses the spatial-temporal positional encodings 818 to indicate the space and time of where an image token should be included in a generated digital video.

To further illustrate, the generative AI digital visual system 102 receives a visual prompt (e.g., a digital image) and further receives instructions indicating that a generated digital video should include a specific object (e.g., a car) portrayed in the digital image at the top right corner of every frame of the generated digital video. In response, the generative AI digital visual system 102 generates the spatial-temporal positional encodings 818 indicating the spatial location (e.g., top right corner) and the temporal location (e.g., every frame of a digital video) by adjusting an associated timestep to indicate that the spatial-temporal positional encodings 818 is fully denoised, and thus, is not denoised during the denoising process.

In some instances, the generative AI digital visual system 102 receives a visual prompt and further receives instructions indicating that a generated digital video should include the entire visual prompt (e.g., a digital image) every 3 seconds (e.g., or at the 25 second mark of the digital video) within a generated digital video. In response, the generative AI digital visual system 102 generates the spatial-temporal positional encodings 818 to conform with the received instructions.

Although FIG. 8 discusses generating the spatial-temporal positional encodings 818 in context of training, in one or more embodiments, the generative AI digital visual system 102 also uses the spatial-temporal positional encodings 818 at inference time. Specifically, in response to an image-to-video request from a client device, the generative AI digital visual system 102 generates spatial-temporal positional encodings for a digital image part of a visual prompt. Furthermore, the generative AI digital visual system 102 generates spatial-temporal positional encodings for any media attributes indicated by a client device.

For instance, the media attributes include a type of media (e.g., an image or a video), a format of the media, a subject matter of the media, a style of the media, a mood or theme, and any additional details (e.g., aspect ratio, frames per second, shot size, camera angle, a type of motion such as zooming in or zooming out, etc.).

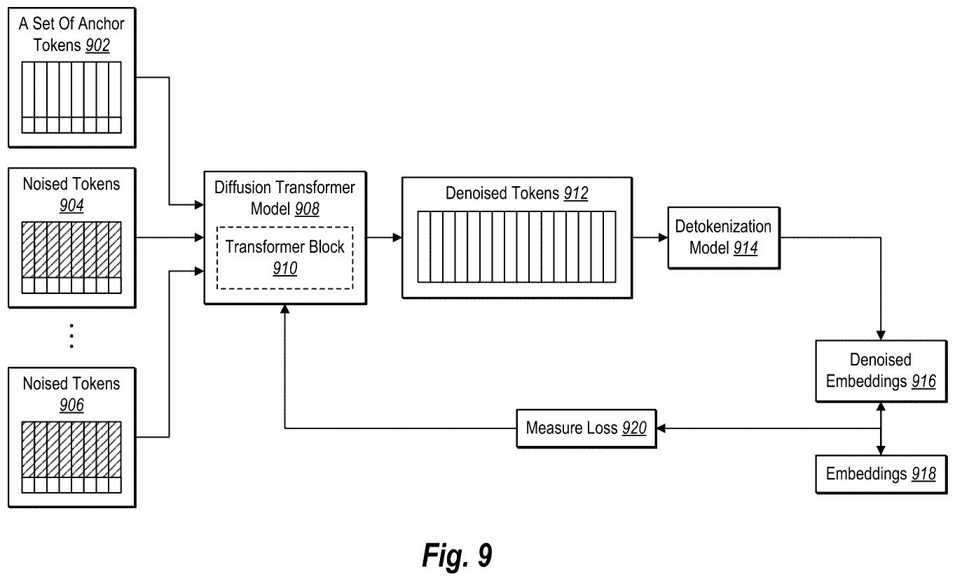

FIG. 9 illustrates the generative AI digital visual system 102 generating a measure of loss and modifying parameters of a diffusion transformer model in accordance with one or more embodiments. As discussed above in FIG. 7, the generative AI digital visual system 102 generates image tokens for a training digital video, adds noise to the image tokens (e.g., a set of training tokens, and the generative AI digital visual system 102 does not add noise to training tokens of an anchor/conditioning frame), and removes noise from the noised tokens (e.g., noised training tokens). Specifically, FIG. 9 shows a set of anchor tokens 902 (e.g., for a conditioning/anchor frame, also known as a set of training anchor tokens), noised tokens 904, and noised tokens 906.

Furthermore, FIG. 9 shows the generative AI digital visual system 102 utilizing a diffusion transformer model 908 (e.g., that includes a transformer block 910) to process the set of anchor tokens 902, the noised tokens 904, and the noised tokens 906. Moreover, FIG. 9 shows the generative AI digital visual system 102 utilizing the diffusion transformer model 908 to generate the denoised tokens 912.

In one or more embodiments, the generative AI digital visual system 102 generates the denoised tokens 912 (e.g., denoised training tokens) from the noised tokens using the diffusion transformer model 908 (e.g., single stream transformer). Specifically, the denoised tokens 912 refers to a clean version of data with the noise added to the token removed. For instance, over a number of denoising timesteps (e.g., transformer blocks), the generative AI digital visual system 102 utilizes the diffusion transformer model 908 to remove the noise from the noised tokens according to the set of anchor tokens 902.

As further shown, the generative AI digital visual system 102 also uses a detokenization model 914 (e.g., the detokenization model 602 described above in FIG. 6) to generate denoised embeddings 916 (e.g., denoised training embeddings). As shown, the generative AI digital visual system 102 compares the denoised embeddings 916 with embeddings 918. Specifically, the embeddings 918 originate from the generative AI digital visual system 102 initially utilizing an encoder to generate embeddings from a sequence of frames of a training digital video (e.g., as shown in FIG. 7). In other words, the generative AI digital visual system 102 compares the pre-tokenized form of the sequence of frames of a training digital video with the denoised embeddings 916 to determine a level of accuracy of the diffusion transformer model 908.

As shown in FIG. 9, the generative AI digital visual system 102 generates a measure of loss 920 from comparing the denoised embeddings 916 and the embeddings 918. In one or more embodiments, the generative AI digital visual system 102 determines the measure of loss 920 by comparing a similarity between a predicted embedding (e.g., denoised embeddings) and a ground truth embedding. Specifically, the generative AI digital visual system 102 determines a mean squared error (MSE) loss to measure an average squared difference between corresponding elements of a predicted embedding and a ground truth embedding. For instance, the goal of MSE loss is to minimize the error between a prediction and a ground truth.

Turning to FIG. 10, additional detail will now be provided regarding various components and capabilities of the generative AI digital visual system 102. In particular, FIG. 10 illustrates an example schematic diagram of a computing device 1000 (e.g., the server(s) 104 and/or the client device 110) implementing the generative AI digital visual system 102 in accordance with one or more embodiments of the present disclosure for components 1000-1012. As illustrated in FIG. 10, the generative AI digital visual system 102 includes a frame anchoring system 105, a diffusion transformer model manager 1002, an image-to-video request manager, an anchor token manager 1006, a digital video manager 1010, and a storage manager 1012.

The diffusion transformer model manager 1002 generates denoised tokens. For example, the diffusion transformer model manager 1002 utilizes a streamlined architecture without additional modulation or conditioning layers to process an input in a single stream manner. Specifically, the diffusion transformer model manager 1002 manages the training and optimization of a diffusion transformer model. For instance, the diffusion transformer model manager 1002 receives a training digital video, generates various embeddings/tokens, and further generates a measure of loss to modify parameters of a diffusion transformer model.

The image-to-video request manager 1004 receives one or more media requests from a client device. For example, the image-to-video request manager 1004 provides a graphical user interface to a client device to input data for an image-to-video request. In one or more embodiments, the image-to-video request manager 1004 provides options for a client device to upload one or more digital images, input text describing unconditional and/or conditional prompt, and further allows for a client device to adjust preset parameters (e.g., digital video parameters such as camera angles, lighting, speed, frame rate, etc.). Moreover, in one or more embodiments, the image-to-video request manager 1004 passes this data to additional components.

The anchor token manager 1006 generates a set of anchor tokens. For example, the anchor token manager 1006 receives a digital image from the image-to-video request manager 1004 and further determines to not add noise to the digital image. Further, the anchor token manager 1006 generates an embedding from the received digital image, and further tokenizes the embedding (e.g., generates a set of image tokens). Moreover, the anchor token manager 1006 adds a timestep embedding to the set of image tokens to indicate that the set of image tokens are fully denoised. In doing so, the anchor token manager 1006 indicates to the diffusion transformer model manager 1002 to use the set of anchor tokens as a guide in removing noise from noised tokens.

The denoised token manager 1008 generates denoised tokens. For example, the denoised token manager 1008 uses a diffusion transformer model to process the set of anchor tokens and noised tokens. Furthermore, the denoised token manager 1008 utilizes multiple transformer blocks of a diffusion transformer model to remove noise from noised tokens to generate a set of denoised tokens.

The digital video manager 1010 generates a digital video. For example, the digital video manager 1010 generates a digital video from denoised tokens. Specifically, the digital video manager 1010 detokenizes denoised tokens and further utilizes a decoder to create a digital video from embeddings (e.g., denoised embeddings). Furthermore, the digital video manager 1010 causes a graphical user interface of a client device to display the generated digital video.

The storage manager 1012 stores various components generated by the generative AI digital visual system 102. For example, the storage manager 1012 stores model parameters (e.g., initial parameters and modified parameters) for a diffusion transformer model, prompts (e.g., visual and textual), generated digital videos in response to prompts, anchor tokens, noised tokens, training digital videos, embeddings, measures of loss, and additional training/initiation data for preparing a diffusion transformer model to generate a digital video from a digital image.

Each of the components 1002-1012 of the generative AI digital visual system 102 can include software, hardware, or both. For example, the components 1002-1012 can include one or more instructions stored on a computer-readable storage medium and executable by processors of one or more computing devices, such as a client device or server device. When executed by the one or more processors, the computer-executable instructions of the generative AI digital visual system 102 can cause the computing device(s) to perform the methods described herein. Alternatively, the components 1002-1012 can include hardware, such as a special-purpose processing device to perform a certain function or group of functions. Alternatively, the components 1002-1012 of the generative AI digital visual system 102 can include a combination of computer-executable instructions and hardware.

Furthermore, the components 1002-1012 of the generative AI digital visual system 102 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 1002-1012 of the generative AI digital visual system 102 may be implemented as a stand-alone application, such as a desktop or mobile application. Furthermore, the components 1002-1012 of the generative AI digital visual system 102 may be implemented as one or more web-based applications hosted on a remote server. Alternatively, or additionally, the components 1002-1012 of the generative AI digital visual system 102 may be implemented in a suite of mobile device applications or “apps.” For example, in one or more embodiments, the generative AI digital visual system 102 can comprise or operate in connection with digital software applications such as ADOBE® FIREFLY, ADOBE® AFTER EFFECTS CC, ADOBE® PREMIERE RUSH, and/or ADOBE® PREMIERE PRO CC.

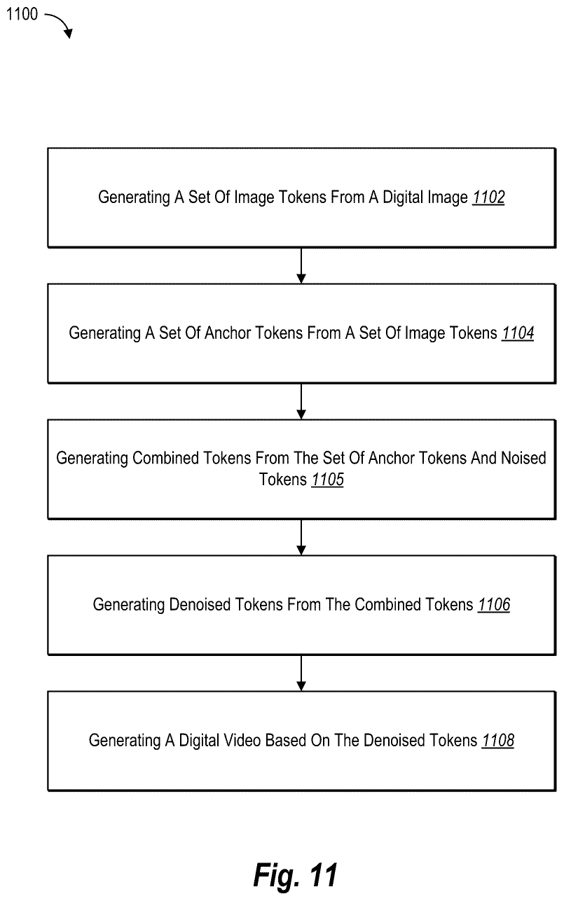

FIGS. 1-10, the corresponding text, and the examples provide a number of different methods, systems, devices, and non-transitory computer-readable media of the 1002-1012. In addition to the foregoing, one or more embodiments can also be described in terms of flowcharts comprising acts for accomplishing the particular result, as shown in FIG. 11. FIG. 11 may be performed with more or fewer acts. Further, the acts may be performed in different orders. Additionally, the acts described herein may be repeated or performed in parallel with one another or in parallel with different instances of the same or similar acts.

FIG. 11 illustrates a flowchart of a series of acts 1100 for generating a digital video based on denoised tokens in accordance with one or more embodiments. FIG. 11 illustrates acts according to one embodiment, alternative embodiments may omit, add to, reorder, and/or modify any of the acts shown in FIG. 11. In some implementations, the acts of FIG. 11 are performed as part of a method. For example, in one or more embodiments, the acts of FIG. 11 are performed as part of a computer-implemented method. Alternatively, a non-transitory computer-readable medium can store instructions thereon that, when executed by at least one processor, cause a computing device to perform the acts of FIG. 11. In one or more embodiments, a system performs the acts of FIG. 11. For example, in one or more embodiments, a system includes at least one memory device. The system further includes at least one server device configured to cause the system to perform the acts of FIG. 11.

The series of acts 1100 includes an act 1102 of generating a set of image tokens from a digital image. Further, the series of acts 1100 includes an act 1104 of generating a set of anchor tokens from a set of image tokens. Further, the series of acts 1100 includes an act 1105 of generating combined tokens from the set of anchor tokens and noised tokens. Moreover, the series of acts 1100 includes an act 1106 of generating denoised tokens from noised tokens and the set of anchor tokens. Further, the series of acts 1100 includes an act 1108 of generating a digital video based on the denoised tokens.

In particular, the act 1102 includes generating, from an image-to-video request comprising a digital image, a set of image tokens from the digital image. Further, the act 1104 includes generating a set of anchor tokens from the set of image tokens by adding a timestep embedding to the set of image tokens that indicates that the set of image tokens are fully denoised. Further, the act 1105 includes generating combined tokens from the set of anchor tokens and noised tokens that are generated from noise. Moreover, the act 1106 includes generating, utilizing a diffusion transformer model to process the combined tokens, denoised tokens. Furthermore, the act 1108 includes generating a digital video comprising at least a portion of the digital image based on the denoised tokens.

For example, in one or more embodiments, the series of acts 1100 includes receiving, from a client device at inference time, the image-to-video request to generate the digital video comprising the digital image and the image-to-video request indicates that the digital image is to be portrayed in the digital video. In addition, in one or more embodiments, the series of acts 1100 includes wherein the image-to-video request indicates that the digital image is to be included as a first frame of a sequence of frames, an intermediate frame of the sequence of frames, or a final frame of the sequence of frames.

Moreover, in one or more embodiments, the series of acts 1100 includes generating, from the digital image of the image-to-video request, an embedding that represents the digital image. Further, in one or more embodiments, the series of acts 1100 includes generating, utilizing a tokenization model to break down the digital image into a plurality of image patches, the set of image tokens from the embedding.

Moreover, in one or more embodiments, the series of acts 1100 includes initializing the noised tokens by sampling a random level of noise from a noise distribution. Further, in one or more embodiments, the series of acts 1100 includes removing noise from the noised tokens according to the set of anchor tokens utilizing the diffusion transformer model.

Moreover, in one or more embodiments, the series of acts 1100 includes generating a sequence of frames from the denoised tokens, wherein the digital video includes the digital image as at least one of a portion of a frame of the sequence of frames, one or more keyframes in the sequence of frames, or one or more motion frames in the sequence of frames.

Additionally, in one or more embodiments, the series of acts 1100 includes generating, from a frame of a sequence of training frames, a training embedding that represents the frame. Moreover, in one or more embodiments, series of acts 1100 includes generating, utilizing a tokenization model, a set of training tokens from the training embedding. Further, in one or more embodiments, the series of acts 1100 includes generating, utilizing the tokenization model, noised training tokens from the sequence of training frames that does not include the frame.

Furthermore, in one or more embodiments, the series of acts 1100 includes generating training anchor tokens by concatenating timestep embeddings to the set of training tokens to indicate that the set of training tokens are fully denoised. Moreover, in one or more embodiments, the series of acts 1100 includes generating, utilizing the diffusion transformer model to process the training anchor tokens and the noised training tokens, denoised training tokens.

Moreover, in one or more embodiments, the series of acts 1100 includes generating, utilizing a detokenization model, denoised training embeddings from the denoised training tokens. Further, in one or more embodiments, the series of acts 1100 includes comparing the denoised training embeddings with embeddings generated from the sequence of training frames prior to tokenization.

Moreover, in one or more embodiments, the series of acts 1100 includes determining a measure of loss from comparing the denoised training embeddings with the embeddings generated from the sequence of training frames prior to tokenization to modify parameters of the diffusion transformer model. In addition, in one or more embodiments, the series of acts 1100 includes generating, from a first pass of the combined tokens through the diffusion transformer model, a conditional token output from the denoised tokens. Further, in one or more embodiments, the series of acts 1100 includes generating, from a second pass of additional combined tokens through the diffusion transformer model, an unconditional token output from additional denoised tokens. Moreover, in one or more embodiments, the series of acts 1100 includes generating a final token output by combining the conditional token output and the unconditional token output. Further, in one or more embodiments, the series of acts 1100 includes generating the digital video comprising at least the portion of the digital image based on the final token output.

Further, in one or more embodiments, the series of acts 1100 includes generating a set of image tokens from a digital image as part of an image-to-video request. Moreover, in one or more embodiments, the series of acts 1100 includes generating, from a first pass of combined tokens through a trained diffusion transformer model, a conditional token output, wherein the combined tokens comprise a set of anchor tokens from the set of image tokens and noised tokens. Further, in one or more embodiments, the series of acts 1100 includes generating, from a second pass of additional combined tokens through the trained diffusion transformer model, an unconditional token output, wherein the additional combined tokens comprise the set of anchor tokens and additional noised tokens. Moreover, in one or more embodiments, the series of acts 1100 includes generating a final token output by combining the conditional token output and the unconditional token output. Further, in one or more embodiments, the series of acts 1100 includes generating a digital video comprising at least a portion of the digital image based on the final token output.

Moreover, in one or more embodiments, the series of acts 1100 includes receiving, from a client device at inference time, the image-to-video request to generate the digital video and a text prompt that indicates that the digital image is to be portrayed in the digital video.

Further, in one or more embodiments, the series of acts 1100 includes receiving, from a client device, the image-to-video request that comprises a conditional prompt for the trained diffusion transformer model to include in the digital video and an unconditional prompt for the digital video. Moreover, in one or more embodiments, the series of acts 1100 includes wherein the conditional prompt indicates that the digital image is to be portrayed as at least one of an initial frame, an intermediate frame, or a subset of frames in the digital video.

Moreover, in one or more embodiments, the series of acts 1100 includes generating text tokens from a conditional prompt of a text prompt of the image-to-video request. Further, in one or more embodiments, the series of acts 1100 includes generating an image embedding from the digital image. Moreover, in one or more embodiments, the series of acts 1100 includes initializing the noised tokens from a noise distribution. Further, in one or more embodiments, the series of acts 1100 includes combining the text tokens, the image embedding, and the noised tokens.

Moreover, in one or more embodiments, the series of acts 1100 includes generating the set of anchor tokens from the image embedding by generating, utilizing a tokenization model to break down the digital image into a plurality of image patches, the set of image tokens from the image embedding. Further, in one or more embodiments, the series of acts 1100 includes adding a timestep embedding to the set of image tokens from the image embedding, wherein the timestep embedding indicates to the trained diffusion transformer model that the set of image tokens are fully denoised.

Moreover, in one or more embodiments, the series of acts 1100 includes generating text tokens from an unconditional prompt of a text prompt of the image-to-video request. Further, in one or more embodiments, the series of acts 1100 includes generating an image embedding from the digital image. Moreover, in one or more embodiments, the series of acts 1100 includes initializing the noised tokens from a noise distribution. Further, in one or more embodiments, the series of acts 1100 includes combining the text tokens, the image embedding, and the noised tokens.

Moreover, in one or more embodiments, the series of acts 1100 includes interpolating, utilizing a classifier free guidance model, between the conditional token output and the unconditional token output, wherein interpolating comprises a guidance scale that encourages the trained diffusion transformer model to generate the digital video based on the conditional token output. Further, in one or more embodiments, the series of acts 1100 includes generating the final token output based on the interpolation of the classifier free guidance model.

Moreover, in one or more embodiments, the series of acts 1100 includes receiving, from a client device at inference time, the image-to-video request to generate the digital video comprising the digital image. Further, in one or more embodiments, the series of acts 1100 includes wherein the image-to-video request indicates that the digital image is to be included as at least one of a portion of a frame of a sequence of frames, one or more keyframes in the sequence of frames, or one or more motion frames in the sequence of frames.

Moreover, in one or more embodiments, the series of acts 1100 includes training the diffusion transformer model by adding noise to a subset of frames of a sequence of frames of a training video, wherein the subset of frames does not include one or more frames that are anchor frames in the training video.

Further, in one or more embodiments, the series of acts 1100 includes generating, from a first pass of the combined tokens through the diffusion transformer model, a conditional token output from the denoised tokens, wherein the combined tokens comprise the set of anchor tokens and the noised tokens. Moreover, in one or more embodiments, the series of acts 1100 includes generating, from a second pass of additional combined tokens through the diffusion transformer model, an unconditional token output from additional denoised tokens, wherein the additional combined token comprise the set of anchor tokens and additional noised tokens. Further, in one or more embodiments, the series of acts 1100 includes generating a final token output by combining the conditional token output and the unconditional token output. In one or more embodiments, the series of acts 1100 includes generating the digital video comprising at least the portion of the digital image based on the final token output.

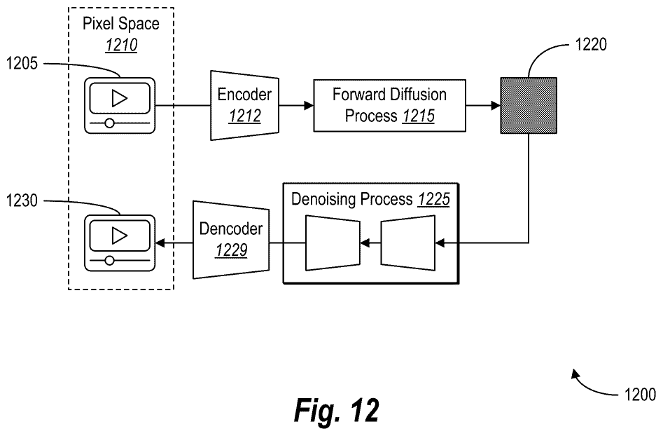

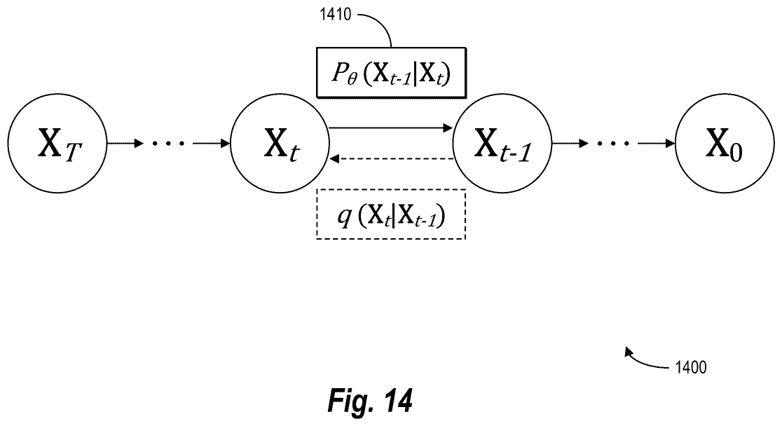

FIG. 12 shows an example of a diffusion model 1200 according to aspects of the present disclosure. In some examples, a diffusion model 1200 describes the operation and architecture of the diffusion transformer model (e.g., single stream diffusion transformer model described above) described with reference to FIG. 14. The diffusion model depicted in FIG. 12 is an example of, or includes aspects of, a generative AI digital visual system 102 as described herein. Specifically, a diffusion transformer model combines principles of diffusion models with principles of transformer models. Accordingly, FIG. 12 shows the generative AI digital visual system 102 initializing a trained diffusion transformer model by leveraging a forward diffusion process to destroy data and then creating media from the destroyed data using a denoising process. In other words, the generative AI digital visual system 102 teaches a diffusion transformer model to create generative content from noise using a forward diffusion process and a denoising process.

As an example, diffusion models are generative models that operate by progressively destroying/noising an input signal and learning to reverse the destroyed data to generate new samples. In particular, diffusion models use a forward diffusion process to add noise over a series of timesteps and a reverse diffusion process to remove noise over a number of timesteps corresponding to the forward number of steps.

As a further example, transformer models are designed for sequence-to-sequence modeling tasks (e.g., tasks that generate based on a sequential order, such as generative tasks that leverage tokens). As mentioned above, transformer models typically include self-attention mechanisms, and multi-layer perceptrons (e.g., feedforward networks to move the data through a transformer architecture). Moreover, transformer architecture typically considers positional information such as the spatial-temporal positional encodings discussed above.

With the context of diffusion models and transformer models discussed above, additional details of how diffusion transformer models meld principles from diffusion models and transformer models together are provided herein. Diffusion transformer models are a class of generative neural networks which can be trained to generate new data with features similar to features found in training data. In particular, diffusion transformer models can be used to generate novel media items such as images, audio files, videos, three-dimensional (3D) models or other digital media items. Diffusion transformer models can be used for various media processing tasks including image super-resolution, generation of media items with perceptual metrics, image inpainting, and media manipulation. In particular, the diffusion transformer models differ from existing diffusion model architecture in that it combines transformer architecture with diffusion principles of removing noise from noised tokens. Specifically, the architecture of a diffusion transformer model in the present disclosure includes a self-attention layer and a multi-layer perceptron. In one or more embodiments, the diffusion transformer model does not include conditioning inputs, rather, position encodings and other (clean) tokens (such as anchor tokens) are included with noised tokens as guidance for how a transformer block should remove noise from a noised token.

In one or more embodiments, the diffusion transformer models leverage the architecture of a transformer model to capture long-range dependencies and complex structures in high-dimensional data. Specifically, the diffusion transformer models operate by processing token data of images and text to fully consider the long-range dependencies. Moreover, the diffusion transformer models use the transformer architecture to predict the denoised data at each timestep (e.g., transformer block) and as discussed above, uses a self-attention mechanism to the noised data to understand how noise should be removed across various noised input tokens.

As discussed in detail above, the generative AI digital visual system 102 utilizes a diffusion transformer model (rather than UNet diffusion architecture) where the generative AI digital visual system 102 leverages encoders (e.g., VAE encoders) to abstract pixel details into latent representations (e.g., embeddings). For instance, the generative AI digital visual system 102 utilizes encoders to abstract pixel data into semantic information which is adaptable for use in a transformer architecture (e.g., a transformer architecture captures global context through attention from the latent representations).

Moreover, in one or more embodiments, rather than injecting diffusion information through an adaLN modulation, the generative AI digital visual system 102 designs a diffusion transformer model a single stream manner. In other words, the generative AI digital visual system 102 utilizes a diffusion transformer model with inputs flowing in and inputs flowing out in a single stream. Thus, in one or more embodiments, the generative AI digital visual system 102 does not utilize adaLN modulation for conditioning inputs, and directly feeds positional encodings, anchor tokens, and/or other encoding information (e.g., token-level diffusion timestep embedding) into a self-attention layer along with nosed tokens.

In one or more embodiments, methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

In one or more embodiments, the generative AI digital visual system 102 utilizes a diffusion process to adds noise to data 1205 to media that has been transformed from a pixel space 1210 to a latent space. For instance, the generative AI digital visual system 102 transforms the data 1205 to the latent space, adds noise to the data 1205 and then denoises noised data 1220 using transformer blocks (e.g., removes noise from the noised tokens to obtain a synthetic media item). Specifically, FIG. 12 shows the data 1220 (e.g., a visual prompt) being processed by an encoder 1212 (e.g., to generate embeddings and then to further generate tokens).

Furthermore, FIG. 12 shows the generative AI digital visual system 102 utilizing a forward diffusion process 1215 to add noise to the data 1205. Moreover, FIG. 12 shows the generative AI digital visual system 102 utilizing a denoising process 1225 to remove noise from noised data 1220. For instance, FIG. 12 shows the generative AI digital visual system 102 utilizing a decoder 1229 to generate media 1230. Further, in one or more embodiments, the generative AI digital visual system 102 adds noise to data in a progressive manner (e.g., over a number of timesteps corresponding to a number of transformer blocks). In doing so, the generative AI digital visual system 102 trains a diffusion transformer model to create generative content from destroyed data (e.g., the noised data 1220).

As just mentioned, FIG. 12 shows the data 1220 being processed by the encoder 1212. As is discussed in some detail above, the diffusion transformer model operates by processing token-level data. To do so, the generative AI digital visual system 102 uses the encoder 1212 to generate embedding(s) of the data 1220 and further transforms the data 1220 into tokens. For instance, the transformation process is referred to as tokenization or patchification. Specifically, tokenization/patchification starts with an image with dimensions of H×W×C, where His the height, W is the width, and C is the number of color channels (3 for RGB images).

In one or more embodiments, the generative AI digital visual system 102 uses patchification to divide the image into patches (e.g., partition the image into non-overlapping patches of size P×P) where each patch contains P×P×C pixel values. Further, for an image of size H×W, the total number of patches will be (H/P)×(W/P). Furthermore, the generative AI digital visual system 102 flattens the image patches into a one-dimensional vector to create a sequence of patch embeddings analogous to text tokens (e.g., in context of natural language processing).

Furthermore, the generative AI digital visual system 102 generates an image token by performing a linear projection to transform an image patch into a fixed-dimensional embedding (d-dimensional vector). In particular, the generated image tokens act as input tokens for the diffusion transformer model.

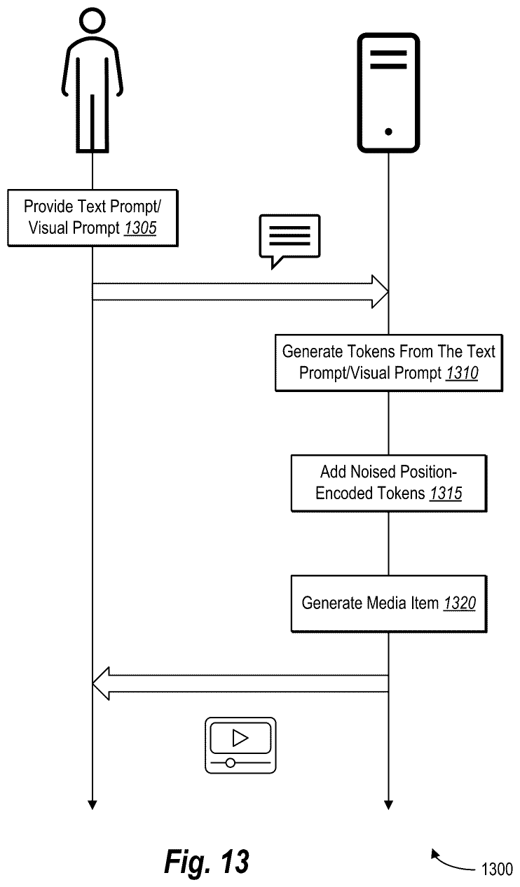

FIG. 13 shows an example of a method 1300 for media generation according to aspects of the present disclosure. In some examples, method 1300 describes an operation of the diffusion transformer model such as an application of the diffusion model 1200 described with reference to FIG. 12. In some examples, these operations are performed by a system including a processor executing a set of codes to control functional elements of an apparatus such as the generative AI digital visual system 102 described above.

Additionally, or alternatively, steps of the method 1300 may be performed using special-purpose hardware. Generally, these operations are performed according to the methods and processes described in accordance with aspects of the present disclosure. In some cases, the operations described herein are composed of various substeps or are performed in conjunction with other operations.

At operation 1305, a user provides a text and/or visual prompt describing content to be included in a generated media item. For example, a user may provide the prompt “a person playing with a cat”. In some examples, guidance can be provided in a form other than text, such as via an image (e.g., a visual prompt), a sketch, an audio input, or a layout.

At operation 1310, the system converts the text prompt (or other prompt guidance) into tokens or other multi-dimensional representation compatible with a single stream diffusion transformer model. For example, text may be converted into a vector or a series of vectors using a transformer model, or a multi-modal encoder. In some cases, the encoder for the generation of tokens is trained independently of the diffusion model (e.g., via a trained dual-VAE model, which is described in DUAL-VAE FOR MORE EFFICIENT AND EFFECTIVE DIFFUSION MODEL TRAINING, and is incorporated by reference above).

At operation 1315, a noise map is initialized that includes random noise. The noise map may be in a pixel space or a latent space. By initializing a media item with random noise, different variations of a media item including the content described by the prompt can be generated. At operation 1320, the system generates a media item based on the noise map, tokens from the prompt (e.g., text prompt and/or visual prompt), and additional spatial-temporal positional encodings.

FIG. 14 shows a diffusion process 1400 according to aspects of the present disclosure. Specifically, FIG. 14 provides additional details of operating principles for a diffusion model. Accordingly, FIG. 14 provides context and details for the principles borrowed from diffusion models to help operate diffusion transformer models. In some examples, diffusion process 1400 describes an operation of the diffusion transformer model, such as the denoising process of a diffusion model 1200 described with reference to FIG. 12.

As described above with reference to FIG. 12, using a diffusion transformer model can involve a process for initializing noise (e.g., generating noised tokens in a latent space) and a denoising process 1410 for denoising the noised tokens to obtain denoised tokens. The denoising process 1410 can be represented as p(xₜ₋₁|xₜ). In some cases, a neural network is trained to perform the denoising process 1410 (i.e., to successively remove the noise).

In an example forward process for a latent diffusion model, the model maps an observed variable x₀ (an embedding in a latent space) intermediate variables x₁, . . . , x_{T} using a Markov chain. The Markov chain gradually adds Gaussian noise to the data (e.g., the embedding, such as a visual signal) to obtain the approximate posterior q(x_{1:T}|x₀) as the latent variables are passed through a neural network such as a diffusion transformer model, where x₁, . . . , x_{T} have the same dimensionality as x₀.

The neural network may be trained to perform the denoising process. During the denoising process 1410, the model begins with noisy data XT, such as a noisy token and denoises the data to obtain the p(xₜ₋₁|xₜ). At each step t−1, the denoising process 1410 takes xₜ, such as first intermediate denoised token, spatial-temporal positional encodings, and tokens (e.g., representing a prompt). Here, t represents a transformer block in a sequence of transformer blocks associated with different noise levels, The denoising process 1410 outputs xₜ₋₁, such as second intermediate denoised token iteratively until x_{T} reverts back to x₀, a completely denoised token. The denoising process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 1 )$$

Moreover, the process of adding noise to data to generate noised tokens is expressed as the joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N(x_{T}; 0, I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output (e.g., using a decoder of a trained dual-VAE model). In some examples, x₀ represents an original clean token, latent variables x₁, . . . , x_{T} represent noisy tokens, and \tilde{x} represents the generated item with high quality.

FIG. 15 is a flow diagram depicting an algorithm as a step-by-step procedure 1500 in an example implementation of operations performable for training a machine-learning model. In one or more embodiments, the procedure 1500 describes an operation of the training component described for configuring a diffusion transformer model. The procedure 1500 provides one or more examples of generating training data, use of the training data to train a machine-learning model, and use of the trained machine-learning model to perform a task.

To begin in this example, a machine-learning system collects training data (block 1502) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1504) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1506). Initialization of the machine-learning model includes selecting a model architecture (block 1508) to be trained. Examples of model architectures include neural networks, diffusion transformer models, transformer models, diffusion models, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1510). The loss function is utilized to measure a difference between an output of the machine-learning model (i.e., predictions) and target values (e.g., as expressed by the training data) to be used to train the machine-learning model. Additionally, an optimization algorithm 1512 is selected that is to be used in conjunction with the loss function to optimize parameters of the machine-learning model during training, examples of which include gradient descent, stochastic gradient descent (SGD), and so forth.

Initialization of the machine-learning model further includes setting initial values (block 1516) of the machine-learning model (block 1514) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1518) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1520), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1520), the procedure 1500 continues training of the machine-learning model using the training data (block 1518) in this example.

If the stopping criterion is met (“yes” from decision block 1520), the trained machine-learning model is then utilized to generate an output based on subsequent data (block 1522). The trained machine-learning model, for instance, is trained to perform a task as described above and therefore once trained is configured to perform that task based on subsequent data received as an input and processed by the machine-learning model.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In one or more embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

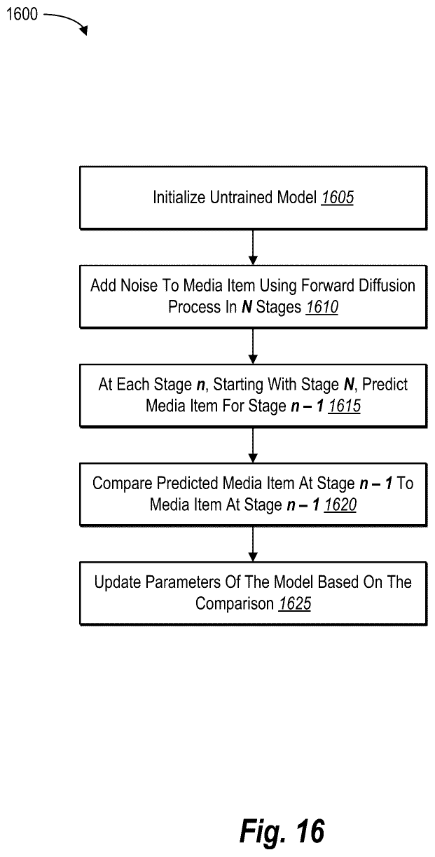

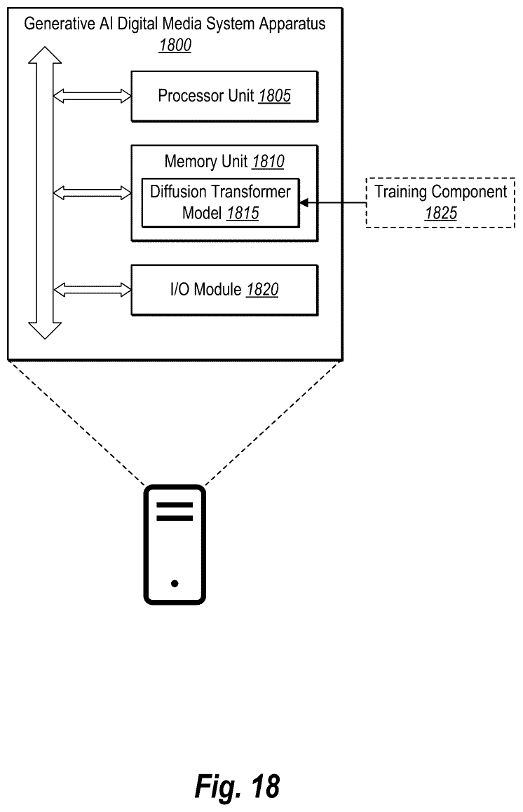

FIG. 16 shows an example of a method 1600 for training a diffusion model according to aspects of the present disclosure. In some embodiments, the method 1600 describes an operation of a training component described for configuring a diffusion transformer model as described with reference to FIG. 18. The method 1600 represents an example for training a reverse diffusion process as described above with reference to FIG. 14. In some examples, these operations are performed by a system including a processor executing a set of codes to control functional elements of an apparatus, such as the guided diffusion model described in FIG. 12.

Additionally, or alternatively, certain processes of method 1600 may be performed using special-purpose hardware. Generally, these operations are performed according to the methods and processes described in accordance with aspects of the present disclosure. In some cases, the operations described herein are composed of various substeps or are performed in conjunction with other operations.

At operation 1605, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1610, the system adds noise to a media item using a forward diffusion process in N stages. In some cases, the forward diffusion process is a fixed process where Gaussian noise is successively added to media item. In latent diffusion models (e.g., the token space), the Gaussian noise may be successively added to features in a latent space.

At operation 1615, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1620, the system compares predicted output (or features) at stage n−1 to an actual media item (or features), such as the output at stage n−1 or the original input. For example, given observed data x, the diffusion model may be trained to minimize the variational upper bound of the negative log-likelihood-log pe (x) of the training data.

At operation 1625, the system updates parameters of the model based on the comparison. For example, parameters of a U-Net may be updated using gradient descent. Time-dependent parameters of the Gaussian transitions can also be learned. However, in some embodiments, for the diffusion transformer model, the system updates parameters of each transformer block using a mean square error denoising loss.

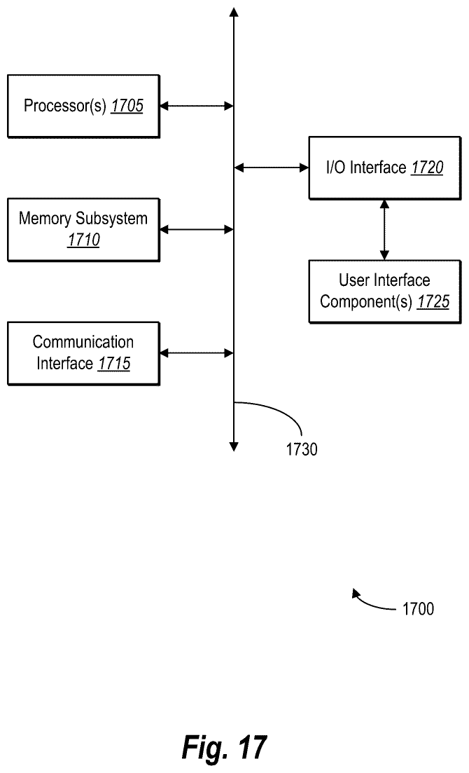

FIG. 17 shows an example of a computing device 1700 according to aspects of the present disclosure. The computing device 1700 may be an example of the generative AI digital media system apparatus (e.g., an apparatus for interacting with the generative AI digital visual system 102, which is described above). In one aspect, computing device 1700 includes processor(s) 1705, memory subsystem 1710, communication interface 1715, I/O interface 1720, user interface component(s) 1725, and channel 1730.

In one or more embodiments, computing device 1700 is an example of, or includes aspects of, the generative AI digital visual system 102 described above. In one or more embodiments, computing device 1700 includes one or more processors 1705 that can execute instructions stored in memory subsystem 1710 to perform media generation.

According to some aspects, computing device 1700 includes one or more processors 1705. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In one or more embodiments, a processor includes special purpose components for modem processing, baseband processing, digital signal processing, or transmission processing.

According to some aspects, memory subsystem 1710 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1715 operates at a boundary between communicating entities (such as computing device 1700, one or more user devices, a cloud, and one or more databases) and channel 1730 and can record and process communications. In some cases, communication interface 1715 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1720 is controlled by an I/O controller to manage input and output signals for computing device 1700. In some cases, I/O interface 1620 manages peripherals not integrated into computing device 1700. In some cases, I/O interface 1720 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1720 or via hardware components controlled by the I/O controller.

According to some aspects, user interface component(s) 1725 enable a user to interact with computing device 1700. In some cases, user interface component(s) 1725 include an audio device, such as an external speaker system, an external display device such as a display screen, an input device (e.g., a remote-control device interfaced with a user interface directly or through the I/O controller), or a combination thereof. In some cases, user interface component(s) 1725 include a GUI.

FIG. 18 shows an example of a generative AI digital media system apparatus 1800 according to aspects of the present disclosure. generative AI digital media system apparatus 1800 may include an example of, or aspects of, the diffusion model described with reference to FIG. 12. In one or more embodiments, generative AI digital media system apparatus 1800 includes processor unit 1805, memory unit 1810, diffusion transformer model 1815, I/O module 1820, and training component 1825. Training component 1825 updates parameters of the diffusion transformer model 1815 stored in memory unit 1810. In some examples, the training component 1825 is located outside the generative AI digital media system apparatus 1800.

Processor unit 1805 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1805 is configured to operate a memory array using a memory controller. In other cases, a memory controller is integrated into processor unit 1805. In some cases, processor unit 1805 is configured to execute computer-readable instructions stored in memory unit 1810 to perform various functions. In some aspects, processor unit 1805 includes special purpose components for modem processing, baseband processing, digital signal processing, or transmission processing. According to some aspects, processor unit 1805 comprises one or more processors described with reference to FIG. 17.

Memory unit 1810 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1805 to perform various functions described herein.

In some cases, memory unit 1810 includes a basic input/output system (BIOS) that controls basic hardware or software operations, such as an interaction with peripheral components or devices. In some cases, memory unit 1810 includes a memory controller that operates memory cells of memory unit 1810. For example, the memory controller may include a row decoder, column decoder, or both. In some cases, memory cells within memory unit 1810 store information in the form of a logical state. According to some aspects, memory unit 1810 is an example of the memory subsystem 1710 described with reference to FIG. 17.

According to some aspects, generative AI digital media system apparatus 1800 uses one or more processors of processor unit 1805 to execute instructions stored in memory unit 1810 to perform functions described herein. For example, the generative AI digital media system apparatus to perform the operations described in the aspects below.

The memory unit 1810 may include a diffusion transformer model 1815 trained to remove noise from noised tokens according to spatial-temporal positional encodings. For example, after training, the diffusion transformer model 1815 may perform inferencing operations as described with reference to FIGS. 12-13 to remove noise from noised tokens and generate media such as video and/or images.

In one or more embodiments, the diffusion transformer model 1815 is an Artificial neural network (ANN). An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes. Specifically, each transformer block of the diffusion transformer model 1815 can represent the connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model. Accordingly, the multi-layer perceptrons within each transformer block of the diffusion transformer model represents various aspects of an ANN.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of the diffusion transformer model 1815 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1825 may train the diffusion transformer model 1815. For example, parameters of the diffusion transformer model 1815 can be learned or estimated from training data and then used to make predictions or perform tasks based on learned patterns and relationships in the data. In some examples, the parameters are adjusted during the training process to minimize a loss function or maximize a performance metric. The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the diffusion transformer model 1815 can be used to make predictions on new, unseen data (i.e., during inference).

I/O module 1820 receives inputs from and transmits outputs of the generative AI digital media system apparatus 1800 to other devices or users. For example, I/O module 1820 receives inputs for the diffusion transformer model 1815 and transmits outputs of the diffusion transformer model 1815. According to some aspects, I/O module 1820 is an example of the I/O interface 1720 described with reference to FIG. 17.

What is claimed:

1. A computer-implemented method comprising:
generating, from an image-to-video request comprising a digital image, a set of image tokens from the digital image;
generating a set of anchor tokens from the set of image tokens by adding a timestep embedding to the set of image tokens that indicates that the set of anchor tokens are fully denoised;
generating combined tokens from the set of anchor tokens and noised tokens that are generated from noise;
generating, utilizing a diffusion transformer model to process the combined tokens, denoised tokens; and
generating a digital video comprising at least a portion of the digital image based on the denoised tokens.

2. The computer-implemented method of claim 1, further comprising:
receiving, from a client device at inference time, the image-to-video request to generate the digital video comprising the digital image and the image-to-video request indicates that the digital image is to be portrayed in the digital video,
wherein the image-to-video request indicates that the digital image is to be included as a first frame of a sequence of frames, an intermediate frame of the sequence of frames, or a final frame of the sequence of frames.

3. The computer-implemented method of claim 1, wherein generating the set of image tokens comprises:
generating, from the digital image of the image-to-video request, an embedding that represents the digital image; and
generating, utilizing a tokenization model to break down the digital image into a plurality of image patches, the set of image tokens from the embedding.

4. The computer-implemented method of claim 1, wherein generating the denoised tokens comprises:
initializing the noised tokens by sampling a random level of noise from a noise distribution; and
removing noise from the noised tokens according to the set of anchor tokens utilizing the diffusion transformer model.

5. The computer-implemented method of claim 1, wherein generating the digital video comprises generating a sequence of frames from the denoised tokens, wherein the digital video includes the digital image as at least one of a portion of a frame of the sequence of frames, one or more keyframes in the sequence of frames, or one or more motion frames in the sequence of frames.

6. The computer-implemented method of claim 1, further comprising training the diffusion transformer model by:
generating, from a frame of a sequence of training frames, a training embedding that represents the frame;
generating, utilizing a tokenization model, a set of training tokens from the training embedding; and
generating, utilizing the tokenization model, noised training tokens from the sequence of training frames that does not include the frame.

7. The computer-implemented method of claim 6, further comprising:
generating training anchor tokens by concatenating timestep embeddings to the set of training tokens to indicate that the set of training tokens are fully denoised; and
generating, utilizing the diffusion transformer model to process the training anchor tokens and the noised training tokens, denoised training tokens.

8. The computer-implemented method of claim 7, further comprising:
generating, utilizing a detokenization model, denoised training embeddings from the denoised training tokens; and
comparing the denoised training embeddings with embeddings generated from the sequence of training frames prior to tokenization; and
determining a measure of loss from comparing the denoised training embeddings with the embeddings generated from the sequence of training frames prior to tokenization to modify parameters of the diffusion transformer model.

9. The computer-implemented method of claim 1, wherein generating the digital video comprises:
generating, from a first pass of the combined tokens through the diffusion transformer model, a conditional token output from the denoised tokens;
generating, from a second pass of additional combined tokens through the diffusion transformer model, an unconditional token output from additional denoised tokens;
generating a final token output by combining the conditional token output and the unconditional token output; and
generating the digital video comprising at least the portion of the digital image based on the final token output.

10. A system comprising:
a memory component; and
one or more processing devices coupled to the memory component, the one or more processing devices to perform operations comprising:
generating a set of image tokens from a digital image as part of an image-to-video request;
generating, from a first pass of combined tokens through a trained diffusion transformer model, a conditional token output, wherein the combined tokens comprise a set of anchor tokens from the set of image tokens and noised tokens;
generating, from a second pass of additional combined tokens through the trained diffusion transformer model, an unconditional token output, wherein the additional combined tokens comprise the set of anchor tokens and additional noised tokens;
generating a final token output by combining the conditional token output and the unconditional token output; and
generating a digital video comprising at least a portion of the digital image based on the final token output.

11. The system of claim 10, wherein the operations comprise receiving, from a client device at inference time, the image-to-video request to generate the digital video and a text prompt that indicates that the digital image is to be portrayed in the digital video.

12. The system of claim 10, wherein the operations comprise:
receiving, from a client device, the image-to-video request that comprises a conditional prompt for the trained diffusion transformer model to include in the digital video and an unconditional prompt for the digital video,
wherein the conditional prompt indicates that the digital image is to be portrayed as at least one of an initial frame, an intermediate frame, or a subset of frames in the digital video.

13. The system of claim 10, wherein generating the combined tokens comprises:
generating text tokens from a conditional prompt of a text prompt of the image-to-video request;
generating an image embedding from the digital image;
initializing the noised tokens from a noise distribution; and
combining the text tokens, the image embedding, and the noised tokens.

14. The system of claim 13, further comprising generating the set of anchor tokens from the image embedding by:
generating, utilizing a tokenization model to break down the digital image into a plurality of image patches, the set of image tokens from the image embedding; and
adding a timestep embedding to the set of image tokens from the image embedding, wherein the timestep embedding indicates to the trained diffusion transformer model that the set of image tokens are fully denoised.

15. The system of claim 10, wherein generating the additional combined tokens comprises:
generating text tokens from an unconditional prompt of a text prompt of the image-to-video request;
generating an image embedding from the digital image;
initializing the noised tokens from a noise distribution; and
combining the text tokens, the image embedding, and the noised tokens.

16. The system of claim 10, wherein combining the conditional token output and the unconditional token output comprises:
interpolating, utilizing a classifier free guidance model, between the conditional token output and the unconditional token output, wherein interpolating comprises a guidance scale that encourages the trained diffusion transformer model to generate the digital video based on the conditional token output; and
generating the final token output based on the interpolation of the classifier free guidance model.

17. A non-transitory computer-readable medium comprising instructions that, when executed by at least one processor, cause the at least one processor to perform operations comprising:
generating, from an image-to-video request comprising a digital image, a set of image tokens from the digital image;
generating a set of anchor tokens from the set of image tokens by adding a timestep embedding to the set of image tokens that indicates that the set of image tokens are fully denoised;
generating combined tokens from the set of anchor tokens and noised tokens that are generated from noise;
generating, utilizing a diffusion transformer model to process the combined tokens, denoised tokens; and
generating a digital video comprising at least a portion of the digital image based on the denoised tokens.

18. The non-transitory computer-readable medium of claim 17, wherein the operations further comprise:
receiving, from a client device at inference time, the image-to-video request to generate the digital video comprising the digital image,
wherein the image-to-video request indicates that the digital image is to be included as at least one of a portion of a frame of a sequence of frames, one or more keyframes in the sequence of frames, or one or more motion frames in the sequence of frames.

19. The non-transitory computer-readable medium of claim 17, wherein the operations further comprise training the diffusion transformer model by adding noise to a subset of frames of a sequence of frames of a training video, wherein the subset of frames does not include one or more frames that are anchor frames in the training video.

20. The non-transitory computer-readable medium of claim 17, wherein generating the digital video comprises:
generating, from a first pass of the combined tokens through the diffusion transformer model, a conditional token output from the denoised tokens, wherein the combined tokens comprise the set of anchor tokens and the noised tokens;
generating, from a second pass of additional combined tokens through the diffusion transformer model, an unconditional token output from additional denoised tokens, wherein the additional combined tokens comprise the set of anchor tokens and additional noised tokens;
generating a final token output by combining the conditional token output and the unconditional token output; and
generating the digital video comprising at least the portion of the digital image based on the final token output.
